(19) United States
(12) Patent Application Publication
(10) Pub. No.: US 2026/0333169 A1
(43) Pub. Date: Oct. 22, 2026

(54) SAFE AUTONOMOUS EVALUATION, DEPLOYMENT, AND ROLLBACK OF NETWORK CONTROL ACTIONS

(71) Applicant: Aglocell Inc., Warrensville, IL (US)

(72) Inventors: Bruce Peterson, Somonauk, IL (US); Pertti Visuri, Fallbrook, CA (US); Randy Salo, La Jolla, CA (US); Sven Seuken, Zurich (CH); Jay Dills, San Diego, CA (US); Fabio Elia Isler, Hünibach (CH); Christian Van Hamersveld, San Marcos, CA (US); Johanna Visuri, Solana Beach, CA (US); Dan Zagursky, San Diego, CA (US)

(73) Assignee: Aglocell Inc., Warrensville, IL (US)

(21) Appl. No.: 19/725,655

(22) Filed: Jun. 30, 2026

Related U.S. Application Data
(63) Continuation-in-part of application No. 19/650,283, filed on Apr. 16, 2026.
Application No. 19/650,283 is a continuation-in-part of application No. 18/818,765, filed on Aug. 29, 2024.
Application No. 18/818,765 is a continuation of application No. 17/990,535, filed on Nov. 18, 2022, now Pat. No. 12,108,298.
Application No. 17/990,535 is a continuation of application No. 16/800,836, filed on Feb. 25, 2020, now Pat. No. 11,510,124.
(60) Provisional application No. 62/810,268, filed on Feb. 25, 2019.

(51) Int. Cl. H04W 36/22; H04W 36/00; H04W 36/14; H04W 36/32

(52) U.S. Cl. CPC H04W 36/22; H04W 36/00837; H04W 36/14; H04W 36/32; H04W 36/324; H04W 36/1446

(57) ABSTRACT

Systems and methods control implementation of network-control actions in a communication network. Telemetry and contextual information associated with a network control context are received, and readiness of the context for action evaluation is determined. Candidate network-control actions are generated, and a post-action state is predicted for one or more candidate actions. The candidate actions are evaluated using predicted state information, historical outcomes, confidence, uncertainty, or combinations thereof. A selected action is validated against safety, policy, and deployment criteria before being provided to a network-control interface. Post-action performance is monitored, and a corrective or rollback action is initiated when observed performance satisfies a rollback condition. Post-action outcomes may update readiness, prediction, action-evaluation, guardrail, rollback, recognized-context, or demand-profile models. Recognized operating contexts may also select context-specific network parameter profiles, prediction models, guardrails, or operating modes.

This application is a continuation-in-part of U.S. patent application Ser. No. 19/650,283, filed on Apr. 16, 2026, which is a continuation-in-part of U.S. patent application Ser. No. 18/818,765, filed on Aug. 29, 2024, which is a continuation of U.S. patent application Ser. No. 17/990,535, filed on Nov. 18, 2022 (now U.S. Pat. No. 12,108,298, issued Oct. 1, 2024), which is a continuation of U.S. patent application Ser. No. 16/800,836, filed on Feb. 25, 2020 (now U.S. Pat. No. 11,510,124, issued on Nov. 22, 2022), which claims priority to U.S. Provisional Patent Application No. 62/810,268, filed on Feb. 25, 2019, all of which are hereby incorporated herein by reference as if set forth in full.

### BACKGROUND

### 1. Field of the Invention

The present invention relates generally to optimization and control of communication networks and, more particularly, to systems and methods for autonomous evaluation, deployment, monitoring, and management of network optimization actions.

In various embodiments, the invention relates to determining whether proposed optimization actions, based on knowledge of the network's situation, should be implemented in an operational communication network, predicting the effects of such actions, validating the actions against operational objectives and constraints, monitoring resulting network performance, and automatically modifying, reversing, or replacing optimization actions based on observed outcomes.

The invention is applicable to wireless communication networks, including cellular radio access networks, self-organizing networks (SON), Open Radio Access Networks (O-RAN), and other communication systems in which network parameters may be adjusted to improve performance, capacity utilization, user experience, reliability, efficiency, or other operational objectives.

### 2. Description of Related Art

Communication networks are increasingly complex systems in which large numbers of configurable parameters affect capacity utilization, service quality, mobility behavior, reliability, energy consumption, and user experience. In wireless communication networks, including cellular radio access networks, such parameters may include handover offsets, cell individual offsets, reselection offsets, thresholds, priorities, hysteresis values, time-to-trigger values, load-balancing parameters, carrier selection parameters, radio access technology selection parameters, and other control parameters that influence how user equipment is distributed among cells, carriers, layers, beams, sectors, or radio access technologies.

Modern cellular networks are also increasingly heterogeneous. A single geographic area may be served by multiple frequency bands, multiple radio access technologies, macro cells, small cells, private network layers, neutral-host systems, or overlapping network layers. Traffic demand, user mobility, interference, signal quality, and cell loading may vary substantially over time and across locations. As a result, a parameter change that improves performance for one source-target relation may be ineffective or harmful for another relation, even within the same cluster or serving cell.

Computer based network planning systems containing a model, a kind of “digital twin”, of the network are routinely used to design networks and to establish the basic set of parameters for them. During network operation self-organizing network systems, centralized SON platforms, radio access network intelligent controllers, O-RAN rApps and xApps, cloud-based optimization systems, and other automated network-management tools may be used to recommend or implement changes to network parameters. Such systems may use rules, heuristics, optimization algorithms, simulations, historical data, machine-learning models, or combinations thereof to identify parameter changes intended to improve network performance. There remains an opportunity and a need to utilize models and digital twins during operation to predict changes, and represent certain recurring network utilization patterns to support better optimization decisions.

However, in each network situation there are several possible parameter changes that could improve its performance. Generating a candidate optimization action is not the same as determining that the action should be deployed into a live operational network. In a production network, an optimization action may create undesirable side effects, including target-cell overload, excessive ping-pong handovers, too-early handovers, too-late handovers, radio link failures, degraded throughput, increased signaling, instability, or conflicts with operator policies or other control loops. These risks become more important as optimization systems become more autonomous and as artificial-intelligence-based systems are used to recommend increasingly complex network changes.

Existing approaches often focus on calculating a recommended parameter value or ranking possible optimization actions. In many cases, the same process that identifies an action also releases the action for implementation. This can be undesirable because action selection and action deployment involve different technical considerations. Action selection is concerned with identifying an action that appears beneficial based on available measurements, objectives, models, or thresholds. Action deployment should also determine whether the action is sufficiently reliable, safe, policy-compliant, and operationally appropriate to be applied to the network before parameter changes are made.

Often, when the demand pattern in a network's coverage area changes, there is a large combination of parameter changes that will be necessary to optimize the network utilization in the new demand situation. Real time network intelligent controllers, O-RAN rApps and xApps, which operate on the basis of real time measurements are often not built to recognize situation changes and therefore cannot benefit from historical knowledge of how to configure the network for each different demand pattern.

Another limitation of some existing systems is that an action may be evaluated primarily from current or historical measurements without separately predicting how the relevant network relation is expected to evolve after the action is applied. A relation may appear suitable for offload or load balancing in its current state, but a parameter change may cause future instability, excessive mobility events, or target overload. Conversely, a smaller or delayed action may produce a more stable improvement. Therefore, there is a need to evaluate candidate actions based not only on the present state of the network, but also on predicted post-action behavior.

In addition, confidence and uncertainty are important in practical network automation. A proposed action may be based on sparse data, stale measurements, unusual traffic conditions, incomplete telemetry, or historical examples that are not sufficiently similar to the current relation. Without an explicit mechanism for assessing confidence or uncertainty, an automated optimization system may recommend actions that appear mathematically attractive but are not sufficiently supported for safe deployment.

Network operators may use global or local network management policies to guard against stability problems that could result from abrupt or excessive parameter changes. Such policies may impose limits on parameter ranges, maximum step sizes, maintenance windows, protected cells, protected bands, target-load ceilings, mobility-quality floors, approval requirements, blast-radius limits, or interactions with other network control functions. A production-grade optimization system should be able to distinguish between actions that are theoretically beneficial but inconsistent with operator policy, and actions that are deployable under applicable policy and safety constraints.

Even when candidate actions are selected using systematic prediction or modeling, internal network dynamics and cross-dependencies among network elements may produce unexpected performance changes. Carefully selected actions can perform differently than expected due to changing traffic, user mobility, interference, weather, outages, special events, neighboring parameter changes, or measurement errors. Accordingly, there remains a need to monitor actual post-deployment performance, compare observed results with expected results, detect drift or degradation, and automatically reverse, reduce, freeze, escalate, or otherwise modify an optimization action when appropriate.

These issues are particularly important in relation-level optimization, where a directed source-target relation may have its own load condition, radio geometry, mobility history, target capacity, user mix, band combination, and policy state. A source cell may be ready to offload traffic to one target but not another. Similarly, a target cell may be suitable for a limited action but unsuitable for a larger action. Treating network optimization only at the cell, cluster, or market level may fail to capture these relation-specific differences.

Accordingly, there remains a need for systems and methods that provide structured control architecture for autonomous network optimization actions. Such systems and methods should preferably be able to determine whether a relation or control context is ready for action, predict the likely effects of candidate actions, evaluate candidate actions using current and historical information, validate selected actions against safety and policy constraints, publish or deploy only actions that satisfy deployment criteria, monitor resulting network behavior, and automatically modify or roll back actions when actual performance indicates degradation, drift, or other undesirable outcomes.

### SUMMARY

In one aspect, systems and methods are provided for a Safe Autonomous Framework for Evaluation, Deployment, and Rollback, (referred to as “SAFE-R framework”), for network optimization actions in a communication network. In various embodiments, the systems and methods receive network telemetry associated with a network control context, determine whether the control context is suitable for an optimization action, utilize recognition of demand patterns based on the telemetry but also external data and knowledge of historical demand patterns, evaluate one or more candidate optimization actions, validate a selected action against deployment criteria, publish or deploy the selected action when the deployment criteria are satisfied, monitor post-deployment performance, and modify or roll back the action when observed performance indicates degradation, drift, policy conflict, or other undesirable behavior.

In one embodiment, the network control context comprises a directed source-target relation in a wireless communication network. The source-target relation may include a source cell, sector, carrier, beam, layer, or radio access technology and a target cell, sector, carrier, beam, layer, or radio access technology. The relation may have its own load condition, radio condition, mobility history, target-capacity condition, user distribution, parameter state, policy state, and prior optimization history.

In some embodiments, the network control context is determined by recognizing a particular situation or event. This can be done based on network telemetry or by external information, for example about ambient conditions. To properly respond to the situation, a whole set of network parameter changes is established utilizing knowledge of historical measurements and network modeling exercises based on a computer model, a digital twin, of the network. For example, knowledge of a sporting or another event in a major venue in the network coverage area can be used to prepare the network configuration. In another example, information about public holidays or extreme weather patterns that could drive more customers in the coverage area to use their terminal devices indoors than in times of good weather. Other simpler factors may be hour of the day and day of the week that drive traffic and time spent at workplaces versus in residential areas.

In one embodiment, a readiness determination stage determines whether the network control context is eligible for action evaluation. The readiness determination may be based on load metrics, radio metrics, mobility metrics, target capacity, historical performance, policy information, contextual information, confidence information, or combinations thereof. The readiness determination may employ probabilistic inference, Bayesian estimation, statistical estimation, rule-based analysis, machine-learning models, historical pattern matching, or other techniques for estimating whether a proposed optimization action is appropriate for the control context.

In one embodiment, a prediction stage estimates an expected post-action state of the network control context for each of a plurality of candidate optimization actions. The expected post-action state may include predicted source load, target load, throughput, handover success, ping-pong rate, too-early handover rate, too-late handover rate, radio link failure risk, signaling load, user experience, or other performance or risk indicators. The prediction stage may employ a state-transition model, Markov model, statistical forecasting model, machine-learning predictor, simulation model, digital-twin model, reinforcement-learning model, graph-based model, or combinations thereof.

In one embodiment, an action evaluation stage evaluates candidate optimization actions based at least in part on current network state, predicted post-action state, historical outcomes, relation-specific context, operator objectives, and uncertainty or confidence information. The action evaluation stage may generate a score, ranking, utility estimate, risk estimate, confidence estimate, or other action-selection output. In some embodiments, the action evaluation stage uses a kernel-based model, similarity-based model, regression model, contextual bandit, reinforcement-learning model, optimization algorithm, heuristic model, or combinations thereof.

In one embodiment, a safety-validation or guardrail stage determines whether a selected candidate optimization action is publishable or deployable. The guardrail stage may apply one or more deployment criteria, including parameter range limits, maximum step-size limits, target-load ceilings, mobility-quality thresholds, confidence thresholds, uncertainty thresholds, rollout limits, maintenance-window restrictions, protected-cell or protected-band rules, approval requirements, conflict rules, or other operator policy constraints. If a highest-ranked action fails one or more deployment criteria, the system may reject the action, select a next-best safe action, reduce the action magnitude, delay publication, route the action for approval, or publish no action.

In one embodiment, a publication stage provides a publishable optimization action to an execution layer, policy layer, operator workflow, network-management system, SON function, O-RAN component, RAN intelligent controller, rApp, xApp, or another network-control interface. The published action may comprise a change to one or more network parameters, including handover parameters, cell individual offsets, reselection offsets, frequency offsets, layer priorities, thresholds, hysteresis values, time-to-trigger values, carrier-selection parameters, radio access technology selection parameters, antenna parameters, load-balancing parameters, or other configurable network-control parameters.

In one embodiment, a monitoring and rollback stage observes post-deployment telemetry after publication or deployment of an optimization action. The system may compare observed performance with expected performance, detect deviation or drift, determine whether performance degradation has occurred, and initiate corrective action when one or more rollback conditions are satisfied. Corrective action may include reverting to a prior parameter value, reducing the magnitude of a parameter change, freezing further changes for a holding interval, selecting an alternative action, escalating to an operator, or otherwise modifying the deployed optimization action.

In one embodiment, post-deployment outcomes are used to update one or more readiness models, prediction models, action-evaluation models, guardrail criteria, confidence estimates, or historical outcome records. The system may thereby support continuous or periodic learning while maintaining safety and policy constraints on deployed actions.

In another aspect, a system is provided comprising one or more processors and one or more memory storing instructions that, when executed by the one or more processors, cause the system to perform any of the methods described herein. In another aspect, a non-transitory computer-readable medium is provided storing instructions that, when executed by one or more processors, cause performance of any of the methods described herein.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 presents a schematic diagram of the process of SAFE-R framework and the modules it may comprise.

FIG. 2 shows a block diagram of an example controller or server configured to perform the methods described herein.

FIG. 3 presents a flowchart of the stages in the SAFE-R framework process

FIG. 4 illustrates relation-level state and action context used by the prediction and action-evaluation stages..

FIG. 5 presents a flowchart of the stages in the SAFE-R framework process for a particular embodiment that uses Bayesian, Markov and Kernel methods in the various stages.

FIG. 6 illustrates a directed relation graph among cells, layers, and carriers and how actions are based on relations rather than only nodes.

FIG. 7 illustrates candidate actions having respective predicted utilities and shows selection or rejection of candidate actions based on applicable guardrails.

FIG. illustrates an example O-RAN or Non-RT RIC implementation of the SAFE-R framework.

FIGS. 9A and 9B illustrate overlapping networks, according to an embodiment;

FIG. 10 illustrates an infrastructure in which disclosed processes may be implemented, according to an embodiment;

FIG. 11 illustrates disclosed processes as they relate to other tools, according to an embodiment;

FIG. 12 illustrates example average load profiles;

FIGS. 13A and 13B illustrate an example process for cross optimization, according to an embodiment;

FIG. 14 illustrates an infrastructure for adjusting parameters, according to an embodiment;

FIG. 15 illustrates overlapping networks, according to an embodiment;

FIG. 16 illustrates an example of a call flow in a network handover scenario, according to an embodiment;

FIG. 17 illustrates parameters that may be adjusted for cross optimization, according to an embodiment;

FIG. 18 illustrates overlapping networks, according to an embodiment;

FIGS. 19A and 19B illustrate the transportation of demand across a large geographic distance, according to an embodiment;

FIG. 20 illustrates an example processing system by which one or more processes described herein may be implemented;

FIG. 21 illustrates example reselection regions under conventional reselection control and cross-optimization reselection control;

FIG. 22 illustrates use of time-of-arrival measurements and adjustment of antenna coverage; and

FIG. 23 illustrates an example feedback process involving network planning, cross-optimization, parameter implementation, performance measurement, and subsequent parameter adjustment.

### DETAILED DESCRIPTION

### 3. Autonomous Network-control Action Architecture

The techniques described herein provide systems and methods for autonomous evaluation, deployment, monitoring, and management of network optimization actions. In some embodiments, the autonomous evaluation, deployment, and rollback architecture described herein may be referred to as a Safe Autonomous Framework for Evaluation, Deployment, and Rollback, or SAFE-R framework. The SAFE-R framework may include one or more stages for readiness determination, post-action prediction, action evaluation, safety validation, publication, monitoring, rollback, and model updating.

In general, the system receives telemetry and contextual information associated with a network control context, determines whether the control context is suitable for action evaluation, predicts the likely effect of one or more candidate actions, evaluates the candidate actions, validates a selected action against safety and policy constraints, publishes or deploys only actions that satisfy deployment criteria, and monitors post-deployment performance to determine whether the action should be maintained, modified, reduced, frozen, escalated, or rolled back. The SAFE-R framework also includes continuous model updating based on the telemetry and observations of the actions and their effects on the network.

In some embodiments, the network control context is a directed source-target relation in a wireless communication network. The source-target relation may be from a source cell, sector, carrier, beam, layer, or radio access technology toward a target cell, sector, carrier, beam, layer, or radio access technology. Each relation may have its own load condition, radio condition, mobility history, target-capacity condition, user distribution, parameter state, policy state, prior optimization history, and contextual state.

The architecture may include a telemetry and context layer, a context and situation recognition stage, a readiness determination stage, a candidate-action generation stage, a post-action prediction stage, an action evaluation stage, a safety-validation or guardrail stage, a publication stage, and a monitoring, rollback, and learning stage. These stages may be implemented as separate software modules or combined in one or more software services.

In some embodiments, the SAFE-R framework operates as a deployment-control layer between an optimization engine that generates candidate actions and one or more network-control interfaces that implement selected actions in an operational network

In some embodiments, the action evaluation stage may use kernel-based neighbor weighting as described herein. In other embodiments, the action evaluation stage may use similarity-based models, regression models, statistical models, machine-learning models, reinforcement-learning models, rule-based models, optimization models, or combinations thereof.

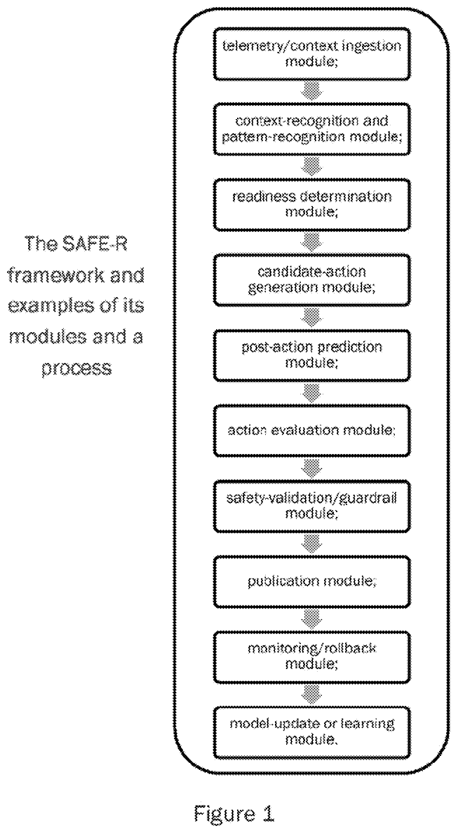

Referring to FIG. 1, an example SAFE-R framework includes a plurality of functional modules or stages configured to evaluate, publish, monitor, and roll back network-control actions. Together they typically form a pipeline consisting of modular steps for implementing the SAFE-R framework, which may include a combination of some or all of the following modules:
telemetry/context ingestion module;
context-recognition and pattern-recognition module;
readiness determination module;
candidate-action generation module;
post-action prediction module;
action evaluation module;
safety-validation/guardrail module;
publication module;
monitoring/rollback module;
model-update or learning module.

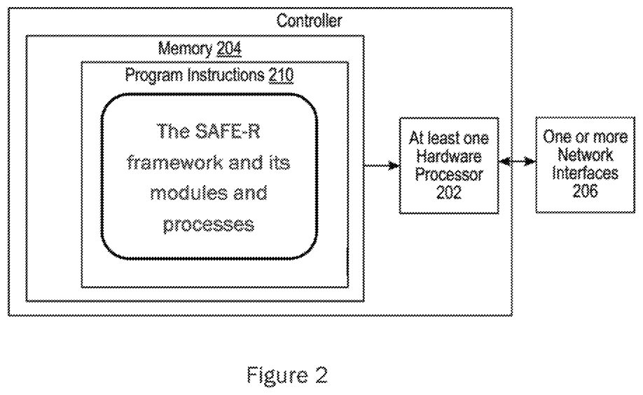

Referring to FIG. 2, the controller for the SAFE-R framework comprises at least one hardware processor 202, memory 204, and one or more network interfaces 206. The memory 204 stores program instructions 210 which, when executed by the processor 202, implement the functions of the SAFE-R framework and its modules and processes.

The following sections describe these modules and processes and present some embodiments in detail.

### 4. Definitions and Terminology

As used herein, the following terms are used for convenience of description and are not intended to limit the disclosed embodiments unless expressly required by the claims.

A “network control context” refers to a network condition, network element, network relation, geographic area, time interval, demand pattern, event condition, parameter set, or other operational context for which one or more network-control actions may be evaluated. A network control context may include, without limitation, a cell, sector, beam, carrier, frequency layer, radio access technology, network slice, cluster, venue area, geographic region, source-target relation, group of relations, or combination thereof. A network control context may also include associated telemetry, historical performance, current parameter values, policy constraints, predicted future state, recognized demand pattern, or external contextual information.

A “source-target relation” refers to a directed relation between a source network element or layer and a target network element or layer in which traffic, demand, user equipment, mobility events, or connection attempts may be influenced or transferred from the source toward the target. The source and target may be cells, sectors, carriers, beams, frequency layers, radio access technologies, network layers, private or public network layers, or networks operated by the same or different operators. A source-target relation may be directional, so that a relation from a first cell to a second cell may be evaluated separately from a relation from the second cell to the first cell. Each source-target relation may have its own load condition, radio condition, mobility history, target-capacity condition, policy state, prior-action history, and rollback history.

A “candidate action” refers to a proposed network-control action that has been generated for evaluation but has not necessarily been approved, published, or deployed in an operational network. A candidate action may include a change to one parameter, a coordinated change to multiple parameters, a selection of a stored parameter profile, a temporary parameter adjustment, a staged rollout action, or a no-change action. Non-limiting examples of candidate actions include changes to cell individual offsets, qOffsetCell, qOffsetFreq, reselection offsets, handover offsets, A3 offsets, A5 thresholds, B1 thresholds, layer priorities, carrier priorities, hysteresis values, time-to-trigger values, antenna tilt values, load-balancing parameters, radio access technology selection parameters, neighbor-list entries, or combinations thereof.

A “published action” refers to a candidate action that has passed one or more deployment criteria and has been provided to an execution layer, network-management system, policy layer, operator workflow, SON function, RAN intelligent controller, O-RAN rApp or xApp, OAM system, settings module, API, or other interface for implementation, approval, scheduling, or use in an operational network. A published action may be implemented automatically, implemented after operator approval, stored for later use, staged for limited rollout, or provided as a recommendation. A published action may therefore include an action that is directly deployed, an action that is queued for deployment, or an action that is made available to another network-control function.

A “post-action state” refers to an estimated, predicted, simulated, or observed state of a network control context after a candidate action or published action is applied. A post-action state may include predicted or observed values of source load, target load, throughput, user experience, handover success, handover failure, ping-pong rate, too-early handover rate, too-late handover rate, radio link failure risk, signaling load, target-cell congestion, connection quality, interference, stability, or policy compliance. A post-action state may be generated by a state-transition model, Markov model, statistical forecasting model, machine-learning model, simulation model, digital-twin model, reinforcement-learning model, graph-based model, rule-based model, or combinations thereof.

A “guardrail” refers to a safety, policy, confidence, uncertainty, operational, or deployment constraint used to determine whether a candidate action may be published or deployed. Guardrails may include, without limitation, maximum or minimum parameter limits, maximum step-size limits, target-load ceilings, mobility-quality floors, handover-success thresholds, ping-pong thresholds, too-early or too-late handover thresholds, radio-link-failure thresholds, confidence thresholds, uncertainty thresholds, maintenance-window restrictions, protected-cell restrictions, protected-band restrictions, protected-cluster restrictions, rollout limits, blast-radius limits, conflict rules, approval requirements, or operator policy rules. A guardrail may be applied before publication, during deployment, or after deployment as part of monitoring and rollback control.

A “rollback action” refers to a corrective action initiated after publication or deployment of a network-control action when observed performance, predicted risk, policy state, or drift from expected behavior satisfies one or more rollback conditions. A rollback action may include reverting to a prior parameter value, reducing the magnitude of a parameter change, stepping down an action, freezing further changes for a holding interval, selecting an alternative action, restoring a prior profile, routing the relation or context for operator review, escalating an alarm, or otherwise modifying or suspending a deployed action. A rollback action need not restore all parameters to an original baseline and may instead partially reverse, attenuate, replace, or pause an action.

A “recognized context”, sometimes referred to as “network situation”, refers to a detected or identified operating situation that may affect network demand, user mobility, radio conditions, traffic mix, or suitability of one or more network-control actions. A recognized context may be determined from network telemetry, historical patterns, external information, operator input, calendar information, event schedules, weather information, public-holiday information, outage information, venue information, transportation information, or combinations thereof. Non-limiting examples include a weekday commuting pattern, evening residential-use pattern, stadium event, concert, convention, public holiday, severe-weather condition, outage condition, seasonal traffic condition, or special-event demand pattern. It also includes signal quality resulting from ambient conditions, for example weather like heavy rain, time of the year and resulting changes in foliage, number of vehicles on the streets or other environmental factors. A recognized context may be used to select candidate actions, initialize readiness priors, select a prediction model, choose a prediction horizon, adjust guardrails, adjust rollback thresholds, select a demand profile, or select an advisory, supervised, or closed-loop operating mode.

A “demand profile” refers to a stored, learned, generated, or selected representation of network demand, traffic distribution, user distribution, load distribution, or associated network-control parameters for a recurring or otherwise identifiable operating condition. A demand profile may be associated with a time of day, day of week, season, event, venue, weather condition, public holiday, demand pattern, geographic region, network layer, or group of source-target relations. A demand profile may include demand maps, parameter settings, candidate actions, published actions, predicted post-action states, guardrail settings, rollback thresholds, historical outcomes, or other information used to configure or evaluate network-control actions for the associated operating condition. In some embodiments, a demand profile is generated from averages over multiple occurrences of a recognized context and is later selected or modified when that context is detected again.

### 5. Telemetry, Context and State Representation

For each serving cell and neighbor cell n, the controller collects the following non-limiting set of basic metrics over a time window (e.g., five or fifteen minutes):
Load and capacity metrics:
   Uₛ: serving-cell utilization, e.g., physical resource block (PRB) utilization, scheduler load, or resource-block occupancy, normalized to a range [0,1].
   Uₙ: neighbor-cell utilization, normalized to [0,1].
   Cₙ: neighbor effective capacity, representing bandwidth, MIMO configuration, and scheduler capability, normalized to [0,1].
   Optionally, a headroom score Hₙ=1−Uₙclipped to [0,1].
Radio feasibility and overlap metrics:
   A reference signal received power (RSRP) estimate at an overlap region between serving and neighbor cells, denoted RSRPₒᵥₑᵣₗₐₚ, which may be obtained from minimization of drive tests (MDT) data or UE measurement reports.
   A signal-to-interference-plus-noise ratio (SINR) at the overlap region.
   A percentage of UEs in the overlap region whose radio conditions exceed specified thresholds.
Mobility performance metrics:
   Handover success rate HSR_{s→n}.
   Ping-pong rate PPR_{s→n}.
   Handover or radio link failure rate HOF_{s→n}.
Risk and constraint indicators:
   Backhaul latency or jitter indicators.
   Coverage priority or “golden neighbor” flags.
   Maximum allowable CIO limits per neighbor (policy bounds).
   Policy-driven exclusions (e.g., prohibited neighbors)

In addition the SAFE-R framework collects context and situational data as well as information about the history of actions and about the policies applicable to the part of the network in question. In addition to the current parameter values, these may include:
prior action history;
policy state;
rollback history;
event state;
time-of-day/day-of-week;
weather;
public holiday;
venue-event information;
historical pattern identifier;
digital-twin or simulation state.

In some embodiments, one or more of these metrics are pre-smoothed using an exponentially weighted moving average (EWMA) to reduce noise.

In one embodiment, the system may ingest any combination of cell, relation, UE aggregate, mobility, and radio features. Non-limiting examples include source utilization, target utilization, PRB usage, handover success rate, handover failure counts, radio link failure counts, too-early handover rate, too-late handover rate, ping-pong rate, user throughput, SINR statistics, RSRP statistics, RSRQ statistics, UE speed mix, traffic class mix, service class mix, event counters, layer priorities, current parameter values, neighbor geometry, target spare capacity, historical changes, time-of-day, day-of-week, special-event indicators, and cluster-level topology metadata and organizes it into a relation state vector, represented as:

x_k=[u_s, u_t, h, p, e, l, q, v, m, theta]\hat{ }T
where, by way of example:
u_s denotes source load or utilization;
u_t denotes target load or utilization;
h denotes handover success or completion quality;
p denotes ping-pong rate;
e denotes too-early handover rate;
l denotes too-late handover rate;
q denotes a radio-quality score or aggregated signal statistic;
v denotes a mobility or speed class indicator;
m denotes current parameter values or action memory;
theta denotes static or slowly varying relation descriptors.

### 6. Initialization Stage

Before the system begins active recommendation, an initialization stage establishes the baseline required for safe optimization. This stage may include relation discovery, relation qualification, historical KPI backfill, prior estimation, action-space configuration, policy threshold loading, and initial model parameter loading.

In one embodiment, each relation is assigned an initial prior readiness distribution based on engineering rules, prior cluster history, market profile, or learned relation templates. The initial stage also defines the allowable candidate action set for the relation and the guardrail policy set used later during publication.

The initialization stage further defines rollback rules. Thus, rollback is operationally executed after publication, but its policy and thresholds are specified during initialization.
b_0(z)=P(z_0=z)
A_r={a_1, a_2, . . . , a_M}
G_r=set of allowed guardrail conditions for relation r

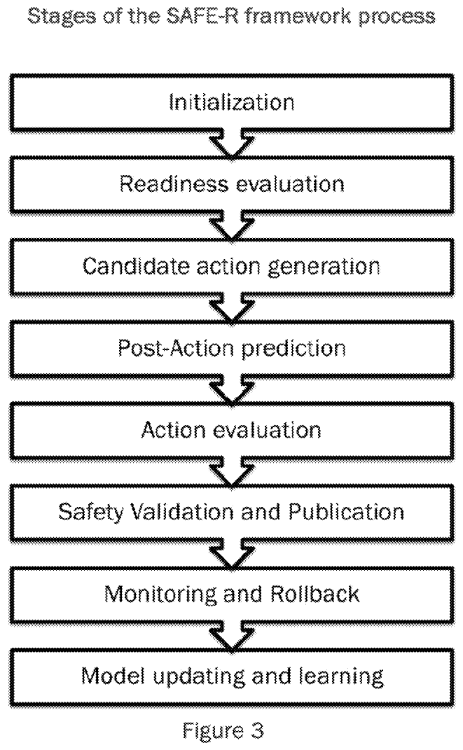

The initialization stage is followed by a specific sequence of stages that will evaluate the readiness of the network for optimization action, generate candidate optimization actions, predict the results of the candidate actions, evaluate the alternative actions, validate the safety of the candidate actions and publish the selected action to the execution interface. These process steps are followed by monitoring of the effects of the published and executed action and possible rollback if needed and finally the framework includes a model updating and learning stage. The stages of the SAFE-R framework are represented in FIG. 3.

### 7. The Readiness Evaluation Stage

The readiness evaluation engine answers a distinct question: Is the relation truly ready for offload now? Rather than directly recommending a parameter change, the readiness engine maintains a latent readiness belief for each relation. Readiness may be determined using probabilistic inference, Bayesian estimation, statistical estimation, rule-based analysis, machine learning, historical pattern matching, or combinations thereof.

In an embodiment Bayesian Readiness Engine is used. The following equations are non-limiting examples of readiness estimation for this method. Other probabilistic, statistical, machine-learning, rule-based, or hybrid readiness models may be used.

In a binary embodiment, a hidden readiness state z_k is defined as:
z_k in {0, 1}, where 0=not ready and 1=ready

A multi-state embodiment may use classes such as Not Ready, Limited Ready, Ready, and Aggressive Ready.

The readiness belief is recursively updated using a Bayes filter. Prediction step: b_bar_k(z)=sum over z′ of P(z_k=z|z_(k−1)=z′, a_(k−1))*b_(k−1)(z′) Update step:
Z_k=sum over z of P(y_k|z_k=z)*b_bar_k(z)
b_k(z)=P(y_k|z_k=z)*b_bar_k(z)/Z_k where Z_k is a normalization factor and y_k is the observation vector at epoch k.

The relation readiness score may be taken as:
R_k=P(z_k=1|y_1:k)=b_k(1)

In one practical embodiment, the observation likelihood is factorized as:
P(y_k|z_k=z)=product over m of P(y_(k,m)|z_k=z)

The likelihood terms may be modeled by Gaussian, log-normal, Beta, categorical, histogram-based, or learned distributions.

A convenient implementation uses odds form:
Odds_k=bar_Odds_k*product over m of LR_m
LR_m=P(y_(k, m)|z_k=1)/P(y_(k, m)|z_k=0)
R_k=Odds_k/(1+Odds_k)
where LR_m is the likelihood ratio for feature m favoring readiness versus non-readiness.

The readiness stage may optionally require that the readiness score exceed a threshold and that the confidence interval around the readiness score remain above a minimum confidence threshold before the relation proceeds to action evaluation.

### 8. Candidate Action Generation Stage

If the readiness engine qualifies the relation, a candidate action generator forms one or more proposed parameter actions. An action may be scalar or vector valued. Non-limiting examples include a change in CIO, qOffsetCell, qOffsetFreq, priority, threshXHigh, threshXLow, threshXHighQ, threshXLowQ, hysteresis, time-to-trigger, B1 threshold, connected-mode measurement priority, antenna tilt, and multi-parameter vectors or any other mobility or offload-related parameter.

For a single-parameter embodiment:
A_r={0, +1, +2} dB CIO

For a multi-parameter embodiment:
a=[Delta CIO, Delta qOffset, Delta priority, Delta threshold]\hat{ }T

### 9. Post-Action Prediction Stage

In one embodiment, a post-action prediction stage estimates source relief, target loading, mobility-quality indicators, and other performance or risk indicators for each candidate action before publication or deployment.

In one implementation, a Markov engine predicts how the relation will evolve after a proposed action. This creates counterfactual foresight and reduces the risk of choosing actions that appear attractive in the present but produce unstable or unsafe future states. The following equations are non-limiting examples of post-action prediction using a Markovian, or state transition model.

The state evolution may satisfy a Markov assumption:
P(x_(k+1)|x_0 . . . x_k, a_0 . . . a_k)=P(x_(k+1)|x_k, a_k)

In one embodiment, the next-state model is linear or locally linear:
x_(k+1)\hat{ }(a)=A*x_k +B*a +c +epsilon_k

In a simpler embodiment, a first-order action impact model is used:
x_(k+1)\hat{ }(a)=X_k+B*a

The matrix or vector B may be learned from historical data and may be specific to market, topology, band combination, traffic class, time context, or relation family. More advanced embodiments may use a switching model, a recurrent model, a graph-based transition model, a mixture-of-experts model, or a digital-twin simulator.

For multi-step prediction over horizon H:
x_(k+H)\hat{ }(a)=A\hat{ }H*x_k+sum from i=0 to H−1 of A\hat{ }i*(B*a+c)

where the formula represents an embodiment in which candidate action a is held constant over the prediction horizon; when actions vary, a may be replaced by an action sequence.

The future state may include predicted source relief, predicted target loading, predicted handover success, predicted ping-pong, predicted too-early rate, predicted too-late rate, predicted radio link failure risk, predicted throughput, or any other KPI or risk indicator.

### 10. Action Evaluation Stage

After the readiness determination stage has determined that a network control context is eligible for action evaluation, and after a candidate-action generation stage has generated one or more candidate actions, an action evaluation stage evaluates the candidate actions. In some embodiments, the action evaluation stage evaluates candidate actions using current network state, predicted post-action state, historical outcomes, recognized context, demand profile information, operator objectives, risk estimates, confidence estimates, uncertainty estimates, or combinations thereof.

The action evaluation stage may generate, for each candidate action, one or more of a score, rank, utility estimate, risk estimate, confidence estimate, uncertainty estimate, or publishability-related indicator. The output of the action evaluation stage may be provided to a safety-validation or publication stage, which may separately determine whether a candidate action is publishable or deployable under applicable guardrails.

The action evaluation stage may be implemented using any suitable evaluation technique, including numerical comparison of predicted post-action indicators, rule-based scoring, optimization, regression, similarity-based modeling, kernel-based modeling, contextual bandit methods, reinforcement learning, statistical learning, machine-learning models, simulation-based scoring, digital-twin scoring, or combinations thereof. Two non-limiting kernel-based embodiments are described below.

### 10.1. Candidate-action Utility Kernel Embodiment

In one embodiment, the action evaluation stage uses a kernel-based candidate-action utility model. This embodiment evaluates candidate actions by comparing a present candidate-action context with historical candidate-action contexts and their observed outcomes. Unlike a neighbor-weighting kernel that directly scores neighbor cells, the candidate-action utility kernel scores candidate actions based on the current state, the predicted post-action state, relation descriptors, recognized context, and historical action outcomes.

In one embodiment, for each candidate action a, a candidate-action context vector c_a is formed. The context vector may include a current state x_k, the candidate action a, a predicted post-action state x_(k+1)\hat{ }(a), and relation descriptors g_r. A non-limiting example is:
c_a=[x_k, a, X_(k+1)\hat{ }(a), G_r]
where x_k represents the current state of the network control context, a represents the candidate action under evaluation, x_(k+1)\hat{ }(a) represents a predicted post-action state if candidate action a is applied, and g_r represents static or slowly varying relation descriptors. Non-limiting examples of relation descriptors include band pair, bandwidth, topology class, distance, overlap score, vendor, network layer, radio access technology, cluster type, venue type, recognized context, demand profile, or policy class.

The candidate-action context vector may be compared with historical context vectors c_i associated with prior evaluated or deployed actions. Each historical context vector may be associated with an observed outcome u_i, such as source-load reduction, target-load increase, throughput change, handover-success change, ping-pong change, too-early handover change, too-late handover change, radio-link-failure change, rollback occurrence, operator approval, or other utility or risk measure.

In one embodiment, an example radial basis function kernel is:
K(c_a, c_i)=exp(−0.5*sum over m of ((c_(a, m)−c_(i, m))\hat{ }2/l_m\hat{ }2))
where l_m represents a length scale associated with feature dimension m. The length scales may be fixed, configured by an operator, learned from historical data, or selected based on recognized context or demand profile.

In one embodiment, a kernel regression utility estimate for candidate action a is computed as:
mu_a=(sum over i of K(c_a, c_i)*u_i)/(sum over i of K(c_a, c_i)+eps) where mu_a represents an expected utility or expected outcome associated with candidate action a.

In one embodiment, an uncertainty estimate associated with candidate action a is computed based on the amount or similarity of historical support for the candidate-action context. A non-limiting example is:
sigma_a=1/Sqrt(sum Over i of K(c_a, C_i)+Eps)
where sigma_a represents a similarity-support uncertainty proxy and eps is a small positive value used to avoid division by zero.

In one embodiment, a risk-adjusted action score is computed as:
J(a)=Mu_a-Kappa_unc*Sigma_a
where kappa_unc represents a risk-sensitivity parameter. In this manner, candidate actions with high expected utility may be penalized when the action is poorly supported by similar historical examples or otherwise has high uncertainty.

A non-limiting utility function used to generate or define u_i or mu_a may include weighted contributions from source relief, throughput improvement, mobility quality, target loading, and risk indicators. For example:
u=w1*Delta source_relief+w2*Delta throughput+w3*Delta HO_success −w4*Delta ping_pong-w5*Delta too_early-w6*Delta too_late
−w7*Target_overload_penalty

Other utility functions may be used, including operator-defined utility functions, policy-based utility functions, multi-objective utility functions, learned utility functions, or utility functions that vary by recognized context or demand profile.

In other embodiments, the candidate-action utility model may use Gaussian processes, kernelized contextual bandits, support-vector-based kernel regressors, kernel ridge regression, hybrid kernel-neural models, nearest-neighbor models, graph kernels, or other similarity-based methods. The candidate-action utility kernel may be used with or without the neighbor-weighting kernel described below.

### 10.2. Neighbor-Weighting Kernel Embodiment

In another embodiment, the action evaluation stage uses a kernel-based neighbor-weighting model. This embodiment evaluates candidate target neighbors for a serving cell and converts resulting neighbor weights into mobility-control parameter changes. Unlike the candidate-action utility kernel, which scores candidate actions using predicted post-action states and historical outcomes, the neighbor-weighting kernel scores neighbor cells or source-target relations based on a feature vector representing suitability of the neighbor or target relation for offload.

In one embodiment, for a serving cell s and its neighbor set N(s), a feature vector x_(s,n) is constructed for each neighbor cell n in N(s). The feature vector may include normalized metrics reflecting load difference between the serving cell and the neighbor, radio feasibility and overlap conditions, historical mobility performance, effective capacity of the neighbor, and risk or penalty indicators. In some embodiments, the feature vector may also include predicted post-action state information, historical relation context, prior action outcomes, recognized context, demand profile information, or other contextual descriptors.

A non-limiting example of a normalized neighbor feature vector is:
x_(s,n)=[Delta U, F_radio, F_mobility, F_capacity, F_risk]
where Delta U represents a normalized load delta between the serving cell and the neighbor cell, F_radio represents a radio feasibility score, F_mobility represents a mobility reliability score, F_capacity represents a capacity score, and F_risk represents a risk or penalty score.

In one embodiment, the load delta is computed as:
Delta U=Clip(u_s−U_n, 0, 1)
after scaling serving-cell utilization U_s and neighbor-cell utilization U_n to a range from 0 to 1. This encourages offload only from a more-loaded source toward a less-loaded neighbor.

In one embodiment, the radio feasibility score F_radio is based on one or more of reference signal received power, signal-to-interference-plus-noise ratio, reference signal received quality, channel quality indicator, overlap-area measurements, minimization-of-drive-test data, UE measurement reports, or a percentage of UEs in an overlap region satisfying one or more radio thresholds. A non-limiting implementation is: F_radio=F_RSRP*F_SINR, where F_RSRP=sigmoid((RSRP_overlap-RSRP_min)/kappa_R) and F_SINR=sigmoid((SINR_overlap-SINR_min)/kappa_S).

In one embodiment, the mobility reliability score F_mobility is based on one or more mobility indicators for the source-target relation. A non-limiting example is:
F_mobility=clip(HSR_(s->n)-alpha_PP*PPR_(s->n)-alpha_HOF*HOF_(s->n), 0, 1)
where HSR_(s->n) represents handover success rate, PPR_(s->n) represents ping-pong rate, HOF_(s->n) represents handover failure or radio-link-failure rate, the KPI rates are normalized to a common range, and alpha_PP and alpha_HOF represent tunable weights.

In one embodiment, the capacity score F_capacity is based on effective target capacity, including one or more of bandwidth, MIMO configuration, scheduler capability, available headroom, or target load. A non-limiting implementation is: F_capacity=clip(C_n*(1−U_n), 0, 1), where C_n represents normalized effective capacity and (1-U_n) represents available target headroom. In one embodiment, the risk score F_risk reflects one or more penalties associated with the neighbor or relation, such as target congestion, backhaul latency, jitter, protected-cell status, protected-band status, policy restrictions, mobility risk, or other KPI risk. A non-limiting implementation is: F_risk=clip(lambda_load*U_n+lambda_policy * P_policy+lambda_backhaul*L_backhaul+lambda_mobility*R_mobility, 0, 1).

Before computing kernel scores, an eligibility gate may exclude or mask neighbor cells or relations that fail one or more eligibility criteria. Non-limiting examples include a neighbor that is not sufficiently less loaded than the serving cell, a neighbor whose overlap radio condition is below a threshold, a relation whose historical mobility KPIs are below minimum thresholds, or a neighbor that is included in a restricted or protected list. A neighbor failing eligibility criteria may be assigned a zero weight or excluded from normalization.

In one embodiment, an ideal offload target vector mu is defined as:
mu_target=[1, 1, 1, 1, 0] corresponding to a large load delta, high radio feasibility, high mobility reliability,
high capacity, and low risk.

A weighted squared norm may be defined as:
∥v∥_Lambda\hat{ }2=sum over i of lambda_i*v_i\hat{ }2
where each feature-weight lambda_i corresponds to a feature dimension.

For each neighbor cell n, a kernel score may be computed using a Gaussian or radial basis function kernel:
k_(s,n)=exp(-∥x_(s,n)-mu_target∥_Lambda\hat{ }2/(2*sigma\hat{ }2))
where sigma is a kernel width parameter that controls discrimination among candidate neighbors.

The kernel scores may be normalized across the neighbor set N(s) to obtain neighbor weights:
E(s)={n in N(s) such that n satisfies eligibility criteria}
w_(s->n)=k_(s,n)/sum over j in E(s) of k_(s,j), for n in E(s); w_(s->n)=0 otherwise

This yields a normalized or probability-like distribution across eligible neighbor cells or source-target relations and facilitates proportional actuation. If E(s) is empty or the denominator is zero, the system may publish no action, hold the relation, or route the relation for operator review.

In one embodiment, a congestion gate g_s is computed to reduce or prevent actuation when the serving cell is not sufficiently congested. A non-limiting example is:
g_s=0, if U_s<=U_lo g_s=(U_s−U_lo)/(U_hi−U_lo), if U_lo<U_s<U_hi g_s=1, if U_s>=U_hi
where U_hi represents a high-utilization trigger threshold and U_lo represents a lower release threshold. Alternative gating functions, including piecewise-linear, sigmoidal, hysteretic, context-dependent, or learned gating functions, may be used.

In one embodiment, the neighbor weights and congestion gate are mapped into cell individual offset changes. Let CIO_(s->n) denote a neighbor offset for neighbor cell n, and let CIO_max denote a maximum allowed offset magnitude. A non-limiting CIO change is:
Delta CIO_(s->n)=
g_s*CIO_step_max*
((w_(s->n)-1/|E(s)|)/(1−1/|E(s)|)), for|E(s)|>1

An updated CIO value may be computed subject to bounds and rate limits:
CIO_(s->n)\hat{ }new=
clip(CIO_(s->n)\hat{ }old+rho*Delta CIO_(s->n), CIO_min, CIO_max)
where rho is a step-size parameter, CIO_step_max limits the candidate update magnitude, and CIO_min and CIO_max define absolute policy bounds.

In some embodiments, the neighbor-weighting kernel may also be used to adjust additional mobility parameters, including A3 event offsets, A5 thresholds, B1 thresholds, qOffsetCell, qOffsetFreq, time-to-trigger, hysteresis, carrier priorities, radio access technology priorities, reselection offsets, or antenna tilt parameters. In some embodiments, preferred neighbors are identified based on a top-K ranking or a weight threshold, and additional mobility parameters are adjusted conservatively to reduce instability or ping-pong behavior.

The neighbor-weighting kernel may operate across frequency bands, network layers, radio access technologies, private or public network layers, or networks operated by the same or different operators. In some embodiments, capacity and radio-feasibility features allow band-neutral selection of target neighbors. In some embodiments, a band-fairness or layer-fairness term may be added to the feature vector or risk component to enforce or encourage target traffic shares across bands or layers.

The neighbor-weighting kernel may be used independently, or as part of the candidate-action utility embodiment. For example, the neighbor-weighting kernel may generate one or more candidate mobility actions, and the candidate-action utility kernel may then evaluate those candidate actions using predicted post-action states and historical outcomes before safety validation and publication.

### 11. Safety Validation and Publication

In one embodiment, the SAFE-R framework includes a safety-validation and publication stage configured to determine whether a selected candidate optimization action is publishable or deployable. The safety-validation and publication stage forms a deployment-control layer that is separate from the action evaluation stage. Thus, even if a candidate action has a high predicted utility, score, rank, or expected benefit, the candidate action is not necessarily published unless it satisfies one or more deployment criteria.

The deployment criteria may include one or more guardrails. Non-limiting examples of guardrails include a readiness threshold, target-load ceiling, mobility-quality floor, handover-success floor, ping-pong ceiling, too-early handover ceiling, too-late handover ceiling, radio-link-failure ceiling, maximum parameter value, minimum parameter value, maximum step size, confidence threshold, uncertainty threshold, maintenance-window restriction, protected-cell rule, protected-band rule, protected-cluster rule, rollout limit, blast-radius limit, conflict rule, approval requirement, policy-version requirement, or other operator policy rule.

In one embodiment, a safe action set is formed for a relation r by applying guardrails to a candidate action set A_r. A non-limiting example of a safe action set is:
Omega_r={a in A_r such that R_k>=theta_R,
u_t\hat{ }(a)<=u_t_max,
h\hat{ }(a)>=h_min,
p\hat{ }(a)<=p_max,
e\hat{ }(a)<=e_max,
l\hat{ }(a)<=l_max,
∥a-a_prev∥_inf<=Delta_max,
sigma_a<=sigma_max,
and policy(a)=true}
where R_k represents a readiness score, theta_R represents a readiness threshold, u_t\hat{ }(a) represents a predicted target load for action a, u_t_max represents a target-load ceiling, h\hat{ }(a) represents predicted handover quality or handover success, h_min represents a minimum handover-quality threshold, p\hat{ }(a) represents a predicted ping-pong rate, p_max represents a ping-pong ceiling, e\hat{ }(a) represents a predicted too-early handover rate, e_max represents a too-early handover ceiling, l\hat{ }(a) represents a predicted too-late handover rate, l_max represents a too-late handover ceiling, a_prev represents a previously deployed action or parameter value, Delta_max represents a maximum allowed component-wise action change, sigma_a represents uncertainty associated with the candidate action, sigma_max represents a maximum uncertainty threshold, and policy(a) represents satisfaction of one or more policy constraints.

In one embodiment, the published action is selected from the safe action set according to an action score or utility value. A non-limiting example is:
a_pub=arg max over a in Omega_r of J(a)
where J(a) represents a utility, risk-adjusted utility, score, ranking value, or other action-evaluation value for candidate action a.

If a highest-ranked or highest-utility candidate action fails one or more guardrails, the system may reject the action, select a next-best safe action, reduce the action magnitude, project the action to a nearest safe value, delay publication, request operator approval, publish no action, or freeze the relation for a holding interval.

A publication stage may provide a publishable optimization action to an execution layer, policy layer, operator workflow, network-management system, SON function, O-RAN component, RAN intelligent controller, rApp, xApp, OAM system, settings module, API, or other network-control interface. In some embodiments, the system operates in an advisory mode, a supervised mode, or a closed-loop mode. In advisory mode, the published action may be provided as a recommendation. In supervised mode, the published action may be routed for operator approval before implementation. In closed-loop mode, the published action may be automatically provided to an execution interface subject to applicable guardrails.

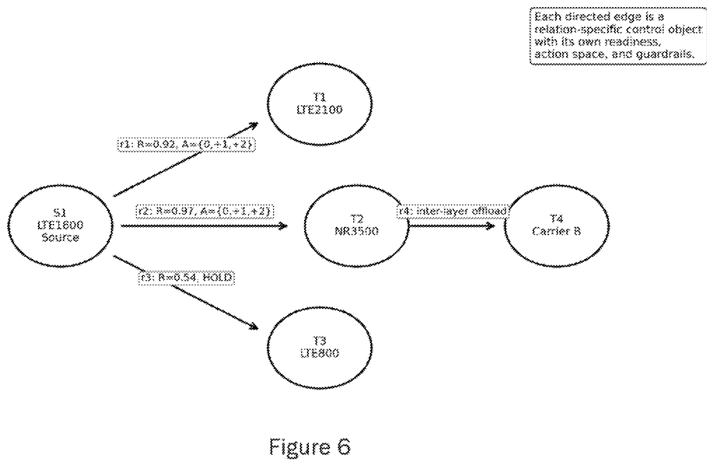

FIG. 6 illustrates an embodiment where the action candidates are based on specific relations between network nodes. The figure should be read edge-by-edge, not node-by-node. For example, relation r1 from source S1 to target T1 may be ready for controlled offload, relation r2 may be highly ready, and relation r3 may be held because its readiness, KPI risk, or policy state is unfavorable. This edge-specific view is one of the aspects of the SAFE-R framework.

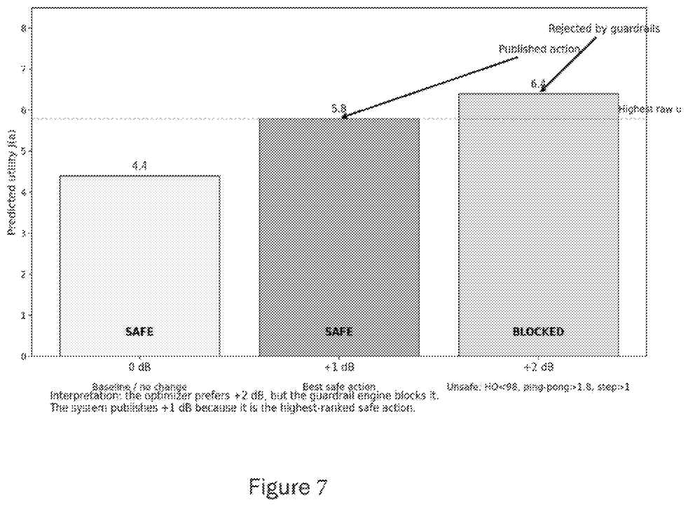

FIG. 7 Shows how the multiple facets of the SAFE-R framework act together to establish the best, but still safe optimization action from several candidates. In the illustrated example, the raw optimizer prefers+2 dB because it has the highest predicted utility. However, that action is blocked by the guardrail engine due to KPI and step-size violations. The system therefore publishes+1 dB, which is the highest-ranked safe action.

### 12. Monitoring and Rollback

After an action is published or deployed, the SAFE-R framework monitors actual post-deployment performance. Monitoring may operate continuously, periodically, event-driven, or in a hybrid manner. The monitored performance may include source load, target load, throughput, handover success, handover failure, ping-pong rate, too-early handover rate, too-late handover rate, radio link failure rate, signaling load, user experience, policy state, or other performance or risk indicators.

The monitoring stage may compare observed post-deployment performance with expected post-action performance. In one embodiment, the system determines whether actual performance deviates from predicted performance by more than a drift threshold. In another embodiment, the system determines whether one or more guardrails that were satisfied before publication are violated after deployment. In another embodiment, the system determines whether a performance degradation, instability condition, policy conflict, or confidence degradation has occurred.

A rollback condition may be expressed in any suitable form. A non-limiting example is:
Rollback if h_actual<h_min OR
p_actual>p_max OR
u_t_actual>u_t_max OR
drift(x_actual, x_predicted)\hat{ }2 2 drift_max
where drift(x_actual, x_predicted)=∥x_actual-x_predicted∥_D and∥v∥_D\hat{ }2=sum over i of d_i*v_i\hat{ }2
where h_actual represents observed handover quality or handover success, p_actual represents an observed ping-pong rate, u_t_actual represents observed target load, drift(actual, predicted) represents a measure of deviation between observed behavior and predicted behavior, and drift_max represents a drift threshold.

If a rollback condition is satisfied, the system may initiate one or more rollback actions. A rollback action may include reverting to a prior parameter value, reducing the magnitude of a parameter change, stepping down the action, freezing further actions for a holding interval, selecting an alternative safe action, restoring a prior demand profile, routing the relation or context for operator review, escalating an alarm, or otherwise modifying or suspending the deployed action.

In one embodiment, rollback may be represented as restoring a previously deployed action or parameter value:
A_(k+1)=A_prev

In another embodiment, rollback may be represented as stepping down the current action:
a_(k+1)=a_k−Delta_a

In another embodiment, rollback may include freezing relation r for T_hold intervals, during which additional actions for the relation are suppressed or require operator approval. In some embodiments, the rollback condition may be required to persist for M out of N monitoring windows, or to breach an EWMA-based threshold, before rollback is initiated, thereby reducing reaction to isolated noisy KPI samples.

Post-deployment outcomes may be used to update one or more models, records, or thresholds used by the SAFE-R framework. For example, the system may update readiness priors, readiness likelihoods, state-transition parameters, Markov transition matrices, prediction models, action-evaluation models, kernel history sets, guardrail thresholds, rollback thresholds, demand profiles, recognized-context profiles, or historical outcome records. Accordingly, the SAFE-R framework may support continuous or periodic learning while maintaining safety and policy constraints on deployed actions.

The system may also generate an audit log for each evaluated, published, withheld, modified, or rolled-back action. The audit log may include the network control context, telemetry inputs, recognized context, readiness score, candidate action set, predicted post-action states, action scores, applied guardrails, published action, observed post-deployment performance, rollback decision, operator approval state, and model-update information. Such logging may support troubleshooting, regulatory compliance, operator review, and further model training.

### 13. Model Updating and Learning

In one embodiment, the SAFE-R framework includes a model-updating and learning stage that uses post-deployment outcomes, historical network data, operator feedback, simulation results, or combinations thereof to update one or more models, thresholds, profiles, or records used by the system. The model-updating and learning stage may operate continuously, periodically, offline, online, or in a hybrid manner.

The information used for model updating may include telemetry collected before an action, the candidate action set evaluated by the system, predicted post-action states, action scores, guardrails applied before publication, the published action, observed post-deployment performance, rollback decisions, operator approvals or rejections, recognized context information, demand profile information, and historical outcomes associated with similar network control contexts.

In some embodiments, the model-updating and learning stage updates one or more readiness models. For example, the system may update readiness priors, readiness likelihood functions, readiness thresholds, confidence estimates, or mappings between observed telemetry and relation readiness. In a Bayesian embodiment, post-deployment outcomes may be used to update prior distributions, likelihood parameters, likelihood ratios, or transition probabilities associated with hidden readiness states. In other embodiments, readiness may be updated using statistical learning, supervised learning, unsupervised learning, reinforcement learning, rule tuning, or historical pattern matching.

In some embodiments, the model-updating and learning stage updates one or more prediction models. For example, the system may update a state-transition model, Markov model, Markov transition matrix, action-effect matrix, regression model, time-series model, graph-based model, simulation model, digital-twin model, or machine-learning predictor. The update may be based on a comparison between predicted post-action states and observed post-deployment states. When actual behavior deviates from predicted behavior, the system may adjust model parameters, increase uncertainty estimates, change a prediction horizon, select a different model for the recognized context, or reduce confidence in similar future actions.

In some embodiments, the model-updating and learning stage updates one or more action-evaluation models. For example, the system may update utility weights, risk weights, kernel feature weights, kernel length scales, kernel width parameters, similarity thresholds, historical outcome libraries, contextual-bandit parameters, reinforcement-learning value estimates, or other scoring parameters used to rank candidate actions. In a kernel-based embodiment, a new post-deployment outcome may be stored as an additional historical example that associates a pre-action state, candidate action, predicted post-action state, recognized context, and observed utility or risk outcome.

In some embodiments, the model-updating and learning stage updates one or more guardrails or rollback criteria. For example, the system may adjust confidence thresholds, uncertainty thresholds, target-load ceilings, handover-quality thresholds, ping-pong thresholds, too-early or too-late handover thresholds, maximum step-size limits, rollout limits, holding intervals, drift thresholds, rollback thresholds, or escalation criteria. Such updates may be constrained by operator policy so that learning does not remove mandatory safety limits or exceed authorized parameter ranges.

In some embodiments, the model-updating and learning stage updates one or more recognized-context models or demand profiles. For example, the system may update a weekday commuting profile, evening residential profile, venue-event profile, holiday profile, weather-related profile, outage profile, or other demand profile based on observed network behavior during one or more occurrences of the associated context. The updated profile may include revised parameter values, revised candidate action sets, revised readiness priors, revised prediction-model selections, revised guardrails, revised rollback thresholds, or revised expected post-action states.

In some embodiments, learning is performed using supervised learning, reinforcement learning, contextual bandit learning, Bayesian updating, Gaussian process regression, kernel regression, clustering, anomaly detection, time-series modeling, graph-based learning, optimization, or combinations thereof. In other embodiments, learning may be performed using rule-based adaptation, statistical estimation, operator-defined update logic, or manual operator feedback. The SAFE-R framework is not limited to any particular learning technique.

In some embodiments, the model-updating and learning stage distinguishes between exploratory learning and production deployment. For example, model parameters may be trained or adjusted using historical data, shadow-mode operation, simulation results, digital-twin results, limited rollout data, or operator-approved trials before being used for closed-loop publication of actions. In some embodiments, a learned model is first operated in an advisory mode, then in a supervised mode, and later in a closed-loop mode after satisfying one or more validation criteria.

In some embodiments, model updates are constrained by one or more safety controls. Such safety controls may include minimum sample-size requirements, confidence thresholds, validation against a holdout data set, simulation validation, operator approval, change-rate limits, maximum permitted changes to model parameters, rollback-aware testing, or suppression of learned changes during abnormal network conditions. The system may also retain prior model versions so that a model update can be reversed if the updated model produces degraded performance.

In some embodiments, the model-updating and learning stage generates or updates an audit record. The audit record may identify the data used for a model update, the model or threshold that was updated, the previous and updated parameter values, the reason for the update, the recognized context associated with the update, the operator approval state, and the measured effect of the update on subsequent network-control actions. Such audit records may be used for troubleshooting, compliance, operator review, model validation, or further training.

Accordingly, post-deployment outcomes may be used to improve future readiness estimation, post-action prediction, action evaluation, safety validation, publication control, rollback control, recognized-context selection, and demand-profile selection while maintaining operator-defined safety and policy constraints.

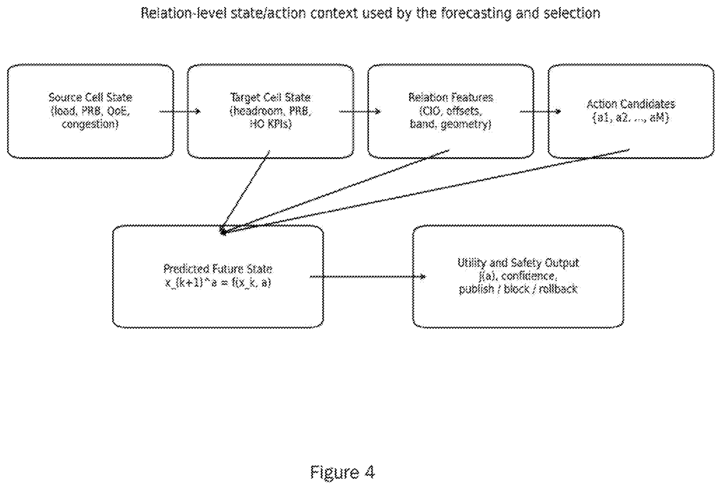

A representation of an embodiment of the SAFE-R frameworks relation level state/action context used by the forecasting and selection engines is illustrated in FIG. 4

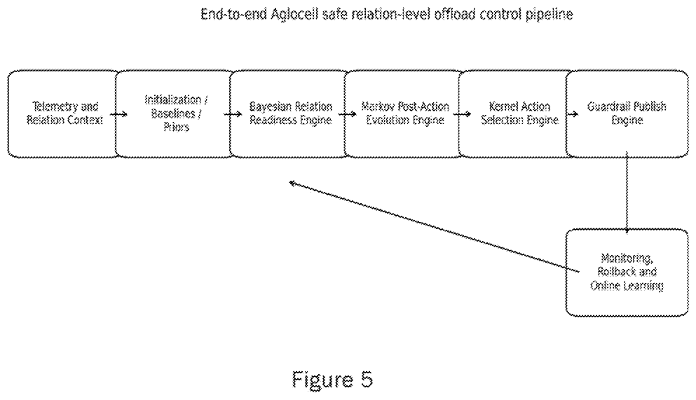

FIG. 5 shows a specific example embodiment of the SAFE-R framework in which the readiness evaluation uses a Bayesian relation based algorithm, the post-action evolution is handled using a Markov chain approach and the action selection utilizes the Kernel evaluation method.

### 14. Implementation Considerations

The described method may be implemented as software modules running on general-purpose server hardware; Virtual network functions (VNFs) or containerized microservices in a cloud-native environment; RIC xApps or rApps in an O-RAN architecture; Proprietary SON modules integrated into vendor-specific RAN management systems. FIG. 8 illustrates how the various modules and the SAFE-R framework logic may run inside a Non-RT RIC rApp or an equivalent operator platform. The various modules, for example, the Bayesian, Markov, kernel, and guardrail stages can remain logically distinct even when deployed within a single service. Publishable outputs may be sent to workflow, approval, policy, or execution systems rather than directly forced into the network.

The technique can run in near-real-time (e.g., 10-30 second windows) or non-real-time (e.g., 5 -15 minute KPI windows), depending on network needs.

In the SAFE-R framework, in other implementations the system may publish to one or more of network management systems supporting:
workflow,
approval,
policy,
execution systems,
operator UI,
R1/A1 interface,
SMO,
RAN Parameter Layer.

In one embodiment, the invention is implemented as an rApp in an O-RAN Non-RT RIC environment. Telemetry is collected from management data, performance management counters, trace data, policy systems, or data platforms. The readiness, forecasting, and selection engines run in one or more cloud services. The guardrail engine may publish recommendations through an R1 interface, a policy interface, an operator approval workflow, or an automated change workflow.

In another embodiment, the invention may recommend values to an external orchestration service rather than directly executing them. This allows the system to support multiple operating modes including advisory mode, supervised mode, and closed-loop mode.

In yet other embodiments, the invention may be packaged within an existing network optimization product or rApp and may be integrated with existing operator data pipelines and change-management processes.

### 15. Application of SAFE-R Framework to Cross-network Load Balancing

One application of the SAFE-R framework in multi-network environments for optimizing the network load across large geographic areas and multiple cells is cross optimization across networks or network layers. The cross-network demand transfer described herein is, in some embodiments, implemented using the kernel-based neighbor weighting and CIO control framework as described herein.

The ability to balance the load and to optimize many functional parameters in cellular networks becomes much better if the optimization can be done across two or more independent frequency bands that are deployed in a particular way. In some cases, there are two layers in a network, both operating in their own frequencies and each providing full coverage for the area to be optimized. These two radio access networks (RANs) may have the same network identifier. In addition, these two RANs may be connected to the same core network, or they may be completely separate networks, each with its own core network owned by a different mobile network operator (MNO). For simplicity, the term “network” will be used herein to denote each independent frequency layer in a network system, even if these frequency layers belong to one mobile operator and share a core network.

In the primary embodiment described herein, there are two or more networks from two or more MNOs participating in the optimization. In this case, each network should have the ability to provide roaming service to mobile devices of the other network(s), and handle the roaming handoffs without interruption in the connection or session. There are well-known solutions for providing roaming services in a network. For example, the ETSI and 3GPP standards specify S10 and S8 interfaces between mobility management entities (MMEs) in each network.

The two or more networks may also have mostly separate and different cell sites. Alternatively, the networks may share a single cell site. In the case of a single shared cell site, the directions of the sector antennas (generally referred to as “Azimuths”) may be different, or the best-server areas may be different between the different networks. This results in a structure in which each serving area of a cell sector in one network layer has partial overlap with serving areas of a number of cell sectors in the other network layer.

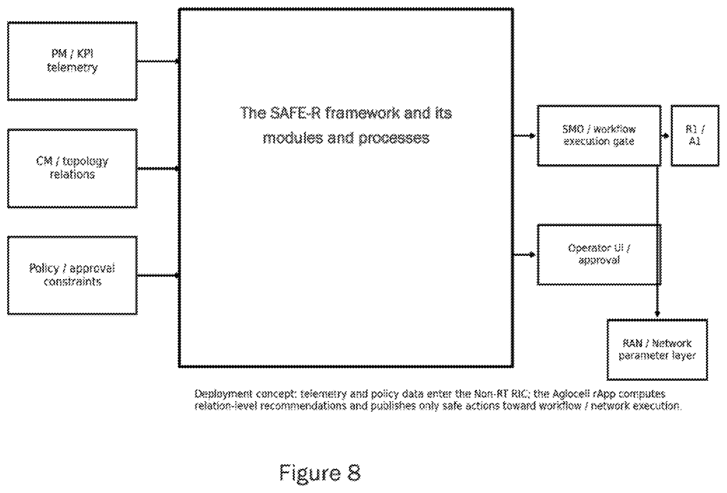

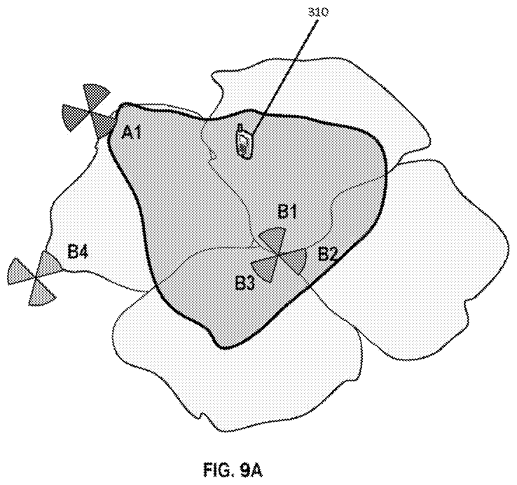

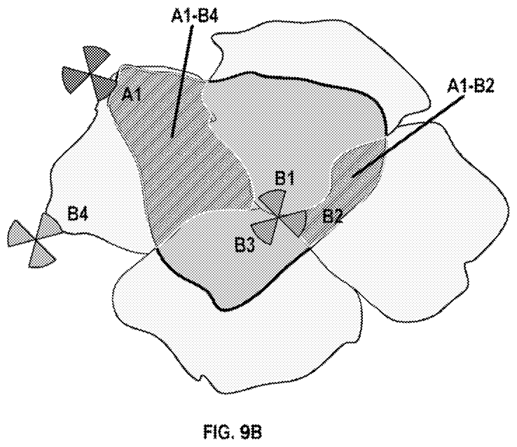

FIG. 9A illustrates an example of the partial overlap areas resulting from different cell sites or different directional orientation of the cell sectors in a single shared cell site, according to an embodiment. Specifically, cell A1 in network A is partially overlapped by four different cell coverage areas in network B (i.e., B1, B2, B3, and B4). This creates four overlap areas. Each of the overlap areas has a unique pair of cells, one from each of networks A and B which are the “best servers” within that overlap area. For example, this means that a mobile device 310 in the overlap area denoted by cells A1 and B1 would be connected to cell A1, if it was served by network A, and to cell B1, if it was served by network B.

As previously discussed, the separate networks A and B may be truly different networks, owned by different MNOs, or may belong to different frequency layers deployed within a network owned by a single MNO. In the illustrated example, each network A and B has complete coverage of the geographic area that will be optimized. However, the techniques described herein can also be applied, to at least some extent, even when complete coverage by both networks A and B is not available. In the majority of cases, the cell sites of competing MNOs are separate and located in different places, with each operator's network utilizing frequency bands that are separate from the other operator's frequency bands. One immediately available method for arranging access to the network topology described above is for an MNO (e.g., the operator of network A) to arrange a roaming agreement with another MNO (e.g., the operator of network B) to have usage access to at least a limited level of the mobile network of that other MNO that is covering the same area.

Cross optimization across the networks of two or more separate MNOs can be very effective in improving the network performance and the economics of network operation, since the network capacity upgrade cycle takes place independently for each of the MNOs. Specifically, as a result of these independent upgrade cycles, the network load in any given location for the two operators is going to be different. In other words, in a location where one mobile network may have a high percentage load and needs capacity, the other network operator will likely have reserve capacity resulting from the nature of its independent upgrade cycle.

However, the cross optimization described herein can also be applied by a single MNO in its own network. In this case, the operator can evolve its network topology to the one illustrated in FIG. 9A. As new frequencies are added or re-farmed from older technologies, they can be deployed in a way that creates the partial overlap described with respect to networks A and B. In addition, the operator can time the network capacity upgrades in the two independent frequency layers A and B deliberately so that they are not happening in the same geographic area at the same time. This will create the desirable situation where one network layer has reserve capacity at the times and locations at which the other network layer has a need for additional capacity.

Alternatively, a single MNO may end up with the network topology, illustrated in 9A, as the result of an acquisition or merger with another MNO. In this case, one MNO generally acquires an independent MNO that has overlapping coverage with its existing network. Thus, the desirable network topology of partial overlapping cells with differing local capacity reserves will be immediately available to the MNO.

Regardless of the scenario in which it occurs, the combination of different reserve capacities in each local area and the partial overlap between cells in the two networks in those local areas makes the proposed cross optimization powerful in providing better optimization for network operations in both networks. Each specific partial overlap area provides an opportunity to transfer mobile devices from one network to another, for example, from one known cell in network A to another known cell in network B.

The total demand of cell A1 in FIG. 9A consists of the data demand of the mobile devices within its coverage area. Each of these mobile devices are in an overlapping coverage area of at least one of cells B1-B4 in network B. If there is a need to reduce load in cell A1, this could be accomplished by transferring mobile devices from cell A1 to any of the cells B1-B4, or to any combination of these four overlapping cells in network B. The standard mechanisms for initiating such handover from one network to another network are discussed elsewhere herein. For now, the focus is on the effect of such transfers on the load (e.g., PRB occupation percentage) in each of the two networks A and B.

The actual load contribution of each of the mobile devices in cell A1 depends, not only on their demand for data, but also on their signal quality. Mobile devices with better signal quality (e.g., higher SINR) will have more efficient data transfer, and therefore, require fewer PRBs to satisfy their data needs than devices with poorer signal quality. Signal quality depends on several factors, including whether the mobile device is inside a building, what obstacles are between the transmitter and the receiver of the wireless signal, and/or the like.

In real-world conditions, the coverage and best-server areas of cells may not be as clear and contiguous, as illustrated in the figures. However, for simplicity of description, the distance between the transmitter and the receiving mobile device may be used herein to represent the signal quality of a connection (i.e., with longer distances representing lower signal quality, and shorter distances representing higher signal quality) or the throughput of mobile devices in a given area.

As illustrated in FIG. 9B, some partial overlap areas in networks A and B are closer to transmitters in network B than they are to transmitters in network A. For instance, the mobile devices in the overlap area A1-B2 are much farther from the transmitter of cell A1 than they are from the transmitter of cell B2. Therefore, moving a mobile device, which is located in overlap area A1-B2, from cell A1 to cell B2 will make a larger contribution to reducing the load in network A, than it will to increasing the load in network B. Therefore, all things equal, such a transfer would be more efficient than, for example, transferring a mobile device that is located in overlap area A1-B4 from cell A1 to cell B4. However, there are other considerations in deciding how to reduce the load in cell A1. For example, the respective load situations and load targets for cells B1-B4 should also be considered.

In any case, it is apparent from FIG. 9B that arranging a partial overlap between two networks A and B, and carefully controlling how much load and demand is transferred from one network to the other, in each partial overlapping area, provides a powerful mechanism for optimizing the specific cell loads in both of the participating networks. Thus, in an embodiment, the disclosed cross optimization comprises analyzing load distributions and other performance parameters, such as throughputs in the two networks, and optimizing the parameters to achieve given targets by selectively transferring connections of mobile devices, from one network to the other network in each of the partial overlap areas for all the cells, utilizing standard connection control and handover mechanisms (e.g., as defined in the 3GPP standards). As used herein, the term “cross optimization” refers to the extension of optimization of wireless networks across network boundaries. These boundaries may include the ownership and control systems of the network (e.g., different MNOs). Alternatively or additionally, these boundaries may include different types of network radio access technology (RAT), including, without limitation, Wi-Fi™, 2G, 3G, 4G, LTE, 5G, and/or the like. For example, network A may be a cellular network (e.g., 2G, 3G, 4G, LTE, 5G, etc.), and network B may be a Wi-Fi™ network.

All optimization can increase efficiency in resource usage. However, expanding the realm of resources to distribute mobile devices across multiple networks provides additional efficiencies in resource usage in wireless communications. Specifically, the disclosed embodiments expand the realm of optimization from a single network to two or more separate overlapping networks. A study of the effects of optimization across existing overlapping networks, which may have already been optimized within their own boundaries, shows that this broader optimization can double the total combined capacity, and dramatically improve the speeds of service that the individual mobile devices on these networks experience.

Another potential benefit of the disclosed cross optimization is that it allows the MNOs and mobile service providers to define the objectives for the network operational parameters, such as peak load levels, such that the cross optimization will reflect these preferences. An ideal scenario for getting the maximum benefit from the disclosed cross optimization includes: (i) independent frequency layers in the two networks to be optimized; (ii) partial overlap of the cells in the two networks; (iii) ability to determine the optimum load transfer between the networks in each of the partial overlap areas of specific network cells; and (iv) mechanisms for controlling the network selection of the mobile devices between the two networks.

### 16. Infrastructure for Cross Optimization

In an embodiment, the disclosed cross optimization is implemented as software, hosted in a cloud infrastructure, and adds a new dimension to managing and optimizing mobile networks. For example, cross optimization enables mobile operators to exchange capacity in LTE and 5G RANs in a controlled manner. Cross optimization may use cloud-computing resources to optimize load distribution and signal conditions across participating networks. This can dramatically reduce cost, improve subscriber experience, and create new opportunities for wholesale revenue.

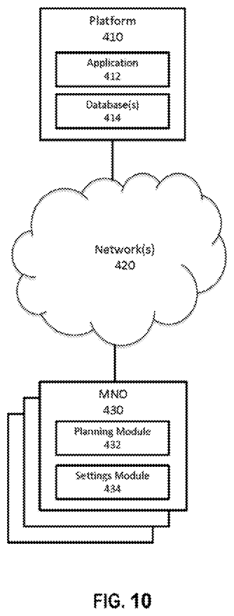

FIG. 10 illustrates an infrastructure in which the disclosed cross optimization operates, according to an embodiment. Specifically, a cross-optimization platform 410 may host and/or execute an application 412, which implements one or more of the various functions, processes, methods, and/or software modules described herein. In addition, platform 410 may comprise or be communicatively connected to one or more databases 414 (e.g., MySQL™, Oracle™, IBM™, Microsoft SQL™, Access™, and the like, including cloud-based databases and proprietary databases). Platform 410 may comprise dedicated servers, or may instead comprise cloud instances, which utilize shared resources of one or more servers. These servers or cloud instances may be collocated and/or geographically distributed. Platform 410 may be communicatively connected to one or more MNO systems 430 via one or more networks 420.

Network(s) 420 may comprise the Internet, and platform 410 may communicate with user system(s) 430 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. It should be understood that references to network(s) 420 which communicatively connect platform 410 to MNO systems 430 are distinct from references to the mobile networks (e.g., networks A and B in FIGS. 9A and 9B) that are being optimized by platform 410.

MNO systems 430 may comprise any type or types of computing devices capable of wired and/or wireless communication, including without limitation, desktop computers, laptop computers, tablet computers, smart phones or other mobile phones, servers, and/or the like. Each MNO system 430 may comprise a planning module 432 and settings module 434. Planning module 432 and settings module 434 may be implemented as software modules executed by the same or different processing devices within MNO system 430.

Platform 410 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 410 transmits or serves one or more screens of the graphical user interface in response to requests from MNO system(s) 430.

In some embodiments, these screens may be served in the form of a wizard, in which case two or more screens may be served in a sequential manner, and one or more of the sequential screens may depend on an interaction of the user or MNO system 430 with one or more preceding screens. The requests to platform 410 and the responses from platform 410, including the screens of the graphical user interface, may both be communicated through network(s) 420, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 414) that are locally and/or remotely accessible to platform 410. Platform 410 may also respond to other requests from MNO system(s) 430.

In embodiments in which a web service is provided, platform 410 may receive requests from MNO systems 430, and provide responses in eXtensible Markup Language (XML), JavaScript Object Notation (JSON), and/or any other suitable or desired format. In such embodiments, platform 410 may provide an application programming interface (API) which defines the manner in which MNO system(s) 430 may interact with the web service. Thus, MNO system(s) 430 (which may themselves be servers), can define their own user interfaces, and rely on the web service to implement or otherwise provide the backend processes, methods, functionality, storage, and/or the like, described herein.

In an embodiment, platform 410 provides a suite of planning tools that enable participating MNOs to choose the mix of savings and user-experience improvements that align with their individual brand strategies. Studies have demonstrated that networks, participating in the disclosed cross optimization, can support up to twice the normal demand. Platform 410 adds a new domain to network optimization in terms of the frequency of adjustments and scope of its focus.

In an embodiment, platform 410 may use information from network planning systems (e.g., planning modules 432), calibrated by field measurements, to adjust existing parameters (e.g., in settings modules 434) on a periodic basis (e.g., daily, weekly, monthly, etc.). Applying these parameter adjustments across more than one mobile network creates additional efficiency because it enables better utilization of all of the capacity within participating networks. The parameter adjustments may add neighbor cells from a partner network (e.g., network B) to specific cells (e.g., cell A1 in network A), and set their handover thresholds to achieve the optimal demand distribution. The neighbor relationships (e.g., the pair of networks A and B) and each demand transfer amount may be calculated based on region-wide network conditions and MNO preferences.

### 17. Potential Benefits of Cross Optimization

Cross optimization can be especially advantageous in dense urban areas, where MNOs tend to allocate continuous capital expenditures for additional network capacity. For example, cross optimization may enhance performance and user experience by improving one or more of the following:
Cell loading, which may be improved by distributing data load more evenly across all participating cells. The cross optimization may employ otherwise idle capacity (e.g., reserve capacity 110) that has been built into networks for future demand growth.
Signal quality, which may be improved by optimizing the signal conditions of mobile devices by connecting mobile devices to cells that can provide the best connection. Often times, the closest cell to a mobile device is one that belongs to a different network.
Interference, which may be improved by the reduction in the level of interference resulting from better load distribution and better signal conditions for data transfers.

The disclosed cross optimization is fundamentally different from ordinary forms of active network sharing, in that it can preserve the relative competitive advantages of all participants. Participating MNOs can benefit from improved performance and efficient resource usage, while simultaneously maintaining their operating and competition strategies. For example, the MNO with the stronger network performance can retain its advantages and pricing premium over other MNOs, while still participating in the disclosed cross optimization with those other MNOs. The ability of platform 410 to maintain relative competitive advantages, results in the continuation of infrastructure-based competition. The participating MNOs are incentivized to continue improving their networks while benefitting from cross optimization. Therefore, cross optimization is well aligned with the objectives of national regulatory authorities. It also complements active network sharing and national roaming, which have been typically restricted to rural, coverage-limited areas by both MNOs and regulators.

In an embodiment, cross optimization transfers a portion of mobile devices between participating networks to optimize service delivery and network usage, according to MNO preferences. Service continuity in inter-system handover can be handled using existing interfaces and protocols of the 3GPP standard. Commercially, the MNOs can choose a “balanced” capacity exchange, where no payments between MNOs are necessary. It is also possible to specify an amount of wholesale capacity sold between MNOs at agreed-upon pricing.

Cross optimization functions in a new, previously untapped domain in the management and optimization of mobile networks. Until now, an MNO had two primary mechanisms to get the best performance at the lowest cost: (1) maintain the best possible structure and configuration of its network to meet subscribers'needs while keeping up with continuously growing data demand; and (2) use the best possible control systems in the real-time operation of its network.

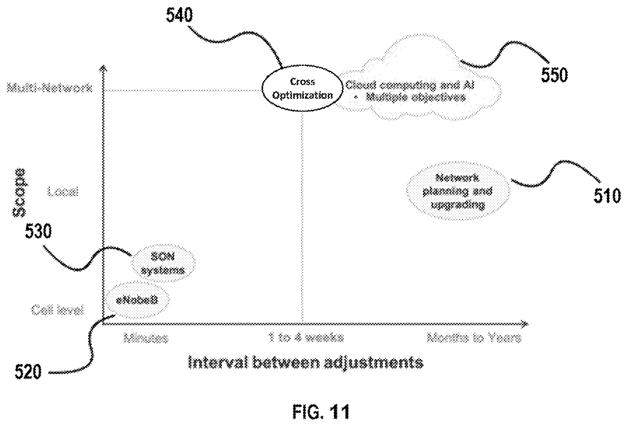

These tools and their respective time/frequency-domains of operation are illustrated in FIG. 11. Network planning tools 510 (e.g., planning modules 432) are used to create accurate models and simulate various demand conditions. The models are fine-tuned with field data to provide the best support for decisions about network upgrades and for setting operations support systems (OSS) parameters. Typical planning cycles are three to six months, often driven by permitting and infrastructure considerations. The interval between changes or adjustments in any particular location can be years depending on the demand growth rate. On the other end of the time scale, feedback loops drive control actions in an eNodeB 520 within milliseconds, and self-optimizing network (SON) systems 530 make parameter adjustments in minutes based on changing conditions measured in real time. In other words, network planning tools 510 have the ability to handle a large number of parameters and have a broad geographic focus, but changes are infrequent and implementation of the results is slow. On the other hand, the control actions in eNodeB 520 and SON systems 530 are frequent, but are based on relatively few measurements in a small part of the network.

In an embodiment, cross optimization 540, as implemented by platform 410, adds a new domain to the management and optimization of mobile networks that is different in terms of scope and frequency of adjustments. Cross optimization 540 has a much broader scope than even network planning systems 510. Cross optimization 540 optimizes demand distribution across several networks, including, in some implementations, across networks of independent, competing MNOs. Cross optimization 540 can consider combinations of hundreds of thousands of variables, including the network choice of mobile devices in several networks across possible transceivers in different frequency bands in multiple networks. This adds completely new degrees of freedom to optimization and makes it possible to define new constraints and objectives. Because cross optimization 540 does not have to be constrained by the real-time feedback loops in eNodeB 520 an SONs 530, the optimization may be performed by powerful computing tools, including massive parallel cloud computing, which may utilize artificial intelligence 550 (e.g., machine learning).

In an embodiment, application 412 of platform 410 receives demand maps from MNO systems 430, and outputs changes and additions to standard mobile network operating parameters, such as neighboring cell lists and their associated CIO values. While this is a very narrow set of parameters, the total number of possible combinations across overlapping cells, potentially in multiple networks, is very large. Thus, application 412 may utilize massive computing resources to provide benefits in cost and performance.

Application 412 may perform its calculations based on a small set of key values that are available from network planning modules 432 of the MNO systems 430. Each planning module 432 may generate and/or maintain a planning model of a network, calibrated by field measurements. Thus, MNOs can study the network performance and load distribution improvements, provided by platform 410, using their own models, before implementing any parameter changes in their networks.

The disclosed cross-optimization approach enables the pursuit of several distinct objectives that may be mutually dependent. For example, application 412 can strive to limit the peak loads in a given region to a specified target value, and, at the same time, preserve the competitive differentiation that exists in the networks. In addition, application 412 can pursue both of these objectives while making sure that the same amount of data usage is transferred out of and into each participating network. Alternatively, if wholesale is desired, application 412 can pursue both objectives while making sure that the specified amount of net data usage takes place.

Regarding the frequency of control actions, platform 410 may operate in between the time domains of network upgrades and SON systems, as illustrated in FIG. 11. For example, in an embodiment, the re-optimization of demand distribution is carried out by application 412 every few weeks (e.g., every 3 weeks). This is more frequent than typical network configuration changes, but without the need for immediate real-time control of a feedback loop. Notably, even when the cross-optimization calculations of application 412 are only performed once a month, platform 410 can still address daily and weekly variations in demand patterns. Specifically, application 412 can optimize the demand and load distribution and the mobile device connection quality based on the situation during different parts of the week (e.g., weekday vs. weekend) and day (e.g., daytime vs. evening).

### 18. Demand Profiles

In a particular implementation, cross optimization is intended to reduce peak loads in a network during the busy hour. The demand map, described herein, may be built based on the longer term (e.g., two-week) average of measured PRB occupation or cell-level average throughput. In this case, the demand map reflects the average- and therefore, anticipated distribution of demand during the busy hour. However, in a wider area, there are several different busy hours. For example, the demand is highest in city centers and office and workplace environments during the middle of the day on weekdays. In residential areas the busy hour is in the evening. Weekends and holidays have their own typical demand patterns.

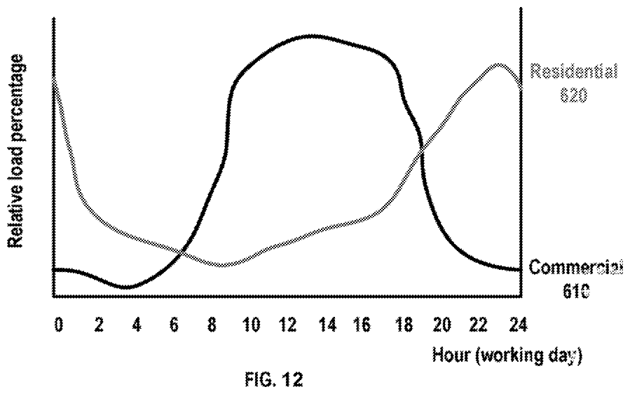

FIG. 12 illustrates typical average load profiles in residential and office and work environments. As illustrated, the demand pattern 610 for a geographic area with mainly office and work facilities peaks during the working hours, whereas the demand pattern 620 in residential areas peaks during the evening hours. In most cases, the demand fluctuations, across various times of day and days of the week, represent a fairly regular, repetitive pattern. In addition, the steady increase in demand, over time, is superimposed on the regular variation pattern at a rate of, generally, a few percent per month.

In an embodiment, planning and simulation, which calculates the demand transfer parameters based on a calibrated demand map from network planning module 432, is normally repeated every month or so. This calculation can be done for each of the typical identified demand patterns. Each of these optimization cycles results in a set of demand transfer parameter settings. A set of these parameter settings for a particular busy hour demand pattern is referred to herein as a “profile” for the specified time interval of the busy hour.

In real-time operation, the parameter settings of the appropriate profile is applied, within the mobile networks of the participating MNOs, during the time of the identified demand pattern associated with those parameter settings in the profile. For example, regarding the regular weekly/daily demand fluctuations, there could be a period of a few hours in the middle of weekdays when a first profile for the mid-day of a workday is applied, and there could be a period in the evening when a second profile for the evening of a workday is applied. In other words, different parameter settings can be applied at different times of the day and/or during different days of the week.

Initially, cross optimization may only be applied for the single busiest period. However, over time, as demand grows without corresponding network upgrades, a more granular set of profiles may be set up. Platform 410 provides tools for analyzing demand patterns and creating and managing these profiles.

In addition to the predictable calendar-based busy-hour demand patterns, there can be other predictable fluctuations. For example, if there is an event venue, such as a sports stadium, concert area, or convention center in the network footprint, there will be a special demand pattern when large crowds gather for scheduled events at the event venue. Additionally, demand patterns may vary based on weather and seasons. Thus, in an embodiment, demand patterns and their associated needs for specific profiles, comprising specific demand transfer parameter settings, may be discovered utilizing information from network operations. For example, application 412 may store a regular feed (e.g., in database(s) 414) of actually experienced cell loads and throughputs from all participating networks (e.g., received from MNO systems 130). Application 412 may use this information to perform sophisticated analysis, using pattern recognition tools, including artificial intelligence (e.g., machine learning), for the purpose of recognizing repeated and predictable demand patterns, for example, to be used to generate new profiles.

In an embodiment, in the collection of the field data for the optimization calculation, application 412 may use averages for multiple occurrences of each repeatable pattern. Then, the planning and simulation model of planning modules 432 may also use these values, which correspond to the long-term, multiple occurrence averages. For example, if the optimization calculation is repeated every four weeks by application 412, the average demand level between 11:00 am and 4:00 pm on weekdays during the past month can be used as the demand level in the model when calculating the demand transfer parameters for the profile for that time period.

In an embodiment, the identification of a particular demand pattern that would benefit from a specific profile is done automatically, in real-time, based on measurements of operating parameters in the network. These parameters can be, for example, PRB occupations from counters in eNodeBs or average cell throughput values. These values, or the conclusions about patterns derived from these values, may be collected from participating networks by application 412, and a coordinated switch from one profile to another can be executed automatically by application 412. This can be done, for example, by a message from the platform 110 to the settings modules 434 of the MNO systems 430 of the affected networks.

The recognized patterns or other external information about distinct Demand Profiles can be used in the SAFE-R framework to do one or more of the following:
choose candidate actions;
initialize readiness priors;
select a Markov/state-transition model;
choose a prediction horizon;
adjust guardrail thresholds;
adjust rollback thresholds;
select a prior parameter profile;
select advisory/supervised/closed-loop mode.

### 19. Details of Cross Optimization

To summarize, an embodiment of the disclosed cross optimization involves arranging access to two networks (e.g., separate networks, or separate network layers within the same network) that operate on separate frequencies and have partially overlapping coverage maps of best service, resulting from differences in cell sites or sector orientation or characteristics, wherein the network layers have different percentage load distributions across the cells in their geographic coverage area, and adjusting the load distribution or other operational characteristics of the two networks or network layers by selectively transferring connections of mobile devices served by each network to the other network in at least some partial overlap areas, utilizing standard cellular-network RRC reconfiguration message parameters. In some embodiments, the determination of neighbor relationships and CIO values is performed using kernel-based scoring of candidate neighbors.

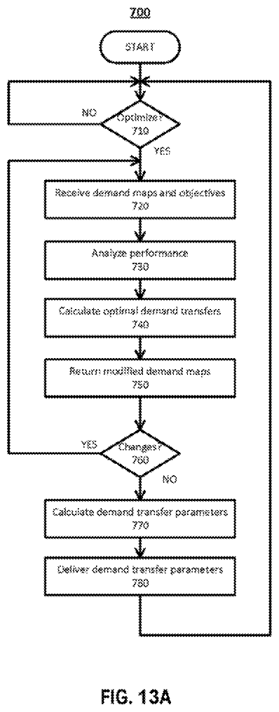

In an embodiment, cross optimization comprises two major steps: (1) planning and simulation; and (2) real-time operation. FIG. 13A illustrates an example process 700 for cross optimizing two or more networks, according to an embodiment. Cross-optimization process 700 may be implemented by application 412 of platform 110. FIG. 13B illustrates the data flow in process 700 between infrastructure components, according to an embodiment. While cross optimization is being described herein with respect to two networks A and B, it should be understood that the same processes and data flows may be applied to three or more networks, and more generally, any plurality of networks, including any plurality of network layers.

In step 710, application 412 determines whether or not to perform an optimization. For instance, optimization for a particular set of networks may be performed periodically (e.g., every week, every few weeks, every month, etc.). Alternatively or additionally, the optimization may be performed in response to a specific request (e.g., from one or more MNO systems 430, a user request via a graphical user interface generated by application 412, etc.). If optimization is to be performed (i.e., “YES” in step 710), application 412 proceeds to step 720. Otherwise (i.e., “NO” in step 710), application 412 continues to wait to perform the next optimization.

During planning and simulation, each of the networks to be optimized may be modeled and simulated, for example, using a planning module 432 of an MNO system 430. Planning module 432 may comprise any standard network planning tool. Examples of planning module 432 include, without limitation, the Atoll™ wireless network engineering software by Forsk S.A.S. of Blagnac, France, Planet™ by Infovista Corporation of Ashburn, Virginia, Asset™ by Teoco of Fairfax, Virginia, and the like. A planning module 432 can be used to generate, for each participating network a model that represents the network topology, location and direction of transmitters and antenna types, terrain, physical environment, and buildings (e.g., through a mechanism called clutter classes), mobile devices and their data traffic, and various network control mechanisms.

The network models of planning modules 432 can be used to generate a demand map that corresponds to the current network load situation in each of the participating networks. Network planning tools typically have a Monte Carlo and/or other simulation mechanism that can generate a distributed set of mobile devices in the model. In this manner, a fixed map of mobile devices is generated across the territory to be optimized. The generation of this map can utilize information about the environment, as represented, for example, by clutter classes.

Next, a set of services may be defined for the mobile devices in the map to create the demand map. The set of services describe the data demand patterns of the mobile devices. A particularly useful way of handling the services is to define an average data demand for each mobile device which will be required by that mobile device for the entire time period of the simulation. This allows for a simple representation and the calculation of average cell loads and average connection parameters in the model. These services can be used to calibrate the demand of the modeled mobile devices so that the load represented in the demand map corresponds to the actual average load levels in the networks to be optimized. The actual measured performance data, together with the modeled and simulated performance, is used to generate the demand map, such that that the demand map is representative of the actual conditions under which the associated network operates.

Next, the fixed demand map (from the models of each participating MNO) for each participating network and frequency band may be used to carry out a detailed network performance simulation using planning modules 432. To explore the effects of future demand levels, the demands in the services used in the fixed mobile device distribution on the demand map can be varied. For example, the growth percentage of mobile peak power demand in the territory to be simulated can be used to analyze the potential of cross optimization for handling the growing demand in future years with fewer network investments.

Using the results of the simulation, the variables describing the signal conditions for each of the fixed subscriber mobile devices in the demand map as well as the actual serving cell identifications can be extracted from the output of the network modeling simulation. These variables, together with the demand map subscriber identification information, may then be transferred to the optimization process, implemented by application 412.

In an embodiment, the data to be transferred to the application 412 is extracted from a standard planning module 432 (e.g., using an export function or a proprietary client application) and sent to application 412 of platform 410. The data to be transferred as a demand map may include one or more of the simulated values of the following parameters: the average demand (e.g., in Megabits per second (Mbps)) across an hour for each point on the calibrated demand map, location (e.g., longitude and latitude, for example, of the Global Positioning System (GPS)) of each modeled mobile device, best-server identifier, peak channel throughput (PCT) (e.g., downlink in Mbps), signal-to-noise ratio (SINR), reference signal received power (RSRP), and/or the like. Simulation results for PCT, SINR, and/or RSRP may be provided in a map grid format that includes the best-server identifier for each point, to enable establishment of the available peak channel throughput and the signal quality and serving cell at any location in the area. In this implementation, there is no need for any geographic or other topology or structural information about the networks. This extraction of data can be carried out for all of the frequency bands of all participating networks of all MNOs, and uploaded to application 412.

In step 720, application 412 receives demand maps for the networks to be optimized and one or more objectives for the cross-optimization. For example, for each participating network, the planning module 432 of the MNO system 130 for that network provides a demand map to application 412. Each demand map may comprise a location for each modeled mobile device, the SINR for each modeled mobile device, a unique identifier for the serving cell of each modeled mobile device, and/or the like. MNO systems 130 may also provide one or more objectives, targets, or preferences to application 412. For example, these objectives can represent target values that may be used to constrain the cross optimization, or may represent other constraints (e.g., a requirement to keep the overall performance differences between the networks the same, a requirement to keep the demand transfer balanced or to a desired amount of wholesale, etc.).

In step 730, application 412 analyzes the initial performance of the participating networks, based on the received demand maps, to obtain one or more parameters for the optimization process. For example, if one of the objectives, received in step 720, is to maintain the relative performance differences between networks, application 412 may analyze the relative performance differences in the various participating networks or combinations of networks (e.g., frequency bands) belonging to each MNO. This is done for the purposes of establishing the relative competitive differences between participating MNOs, so that this information can then be used to set the constraints for optimization.

In step 740, using the demand maps and objectives received in step 720 and the parameters obtained in step 730, application 412 creates a set of candidate optimization actions, for example to transfer the modeled mobile devices in the fixed demand maps for networks A and B between a serving cell in network A and a serving cell in network B to improve the load conditions in the networks A and B towards the set objectives. Objectives for variables, such as network speed or speed distribution, can also be used in determining which mobile devices in the fixed demand maps are transferred between networks A and B.

Another separate but possibly related and dependent constraint that may be imposed on the optimization calculation concerns the amount of actual data capacity used by each MNO from the networks of other participating MNOs in a select period of time. It is possible to balance the transfers, so that the total amount of data capacity each MNO receives (uses) from other MNOs during a period (e.g., during a calendar month) is equal to the total amount of data capacity other MNOs receive (use) in their network. In this manner, the whole exchange can be considered a barter in which each MNO gives up underutilized capacity and receives much needed capacity to relieve load in their highly loaded cells. Alternatively or additionally, a specified amount of net data capacity transfer can be specified as a constraint for the optimization. This enables wholesale of underutilized capacity between MNOs.

As discussed above, each MNO may provide its own specific objective(s) and/or constraint(s) for the cross optimization. The key parameters for these objectives may include, without limitation, one or more of the following:

Load level targets for each area in the network. For example, each MNO can set the peak load percentage that should not be exceeded by more than a few cells. This limit is normally a key parameter in the MNO's existing policies and practices for deciding about network upgrades.

Locations and time. Each MNO can specify the area of the network and the times of day and week during which they would like to optimize network performance. The benefits are higher during times and in areas in which two or more MNOs participate.

Whether selling or buying is acceptable. If wholesaling of capacity is not desired, application 412 may optimize demand transfers in a way that the amount of data usage removed from and added to each network is balanced. In this case, MNOs effectively trade capacity from the underutilized parts of their networks for capacity in areas where they have a high load and can benefit from additional capacity.

In an embodiment, if no wholesale is included, application 412 calculates the demand transfers in a way that preserves the initial relative performance differences between the participating networks. For example, if there is initially a 10% difference in the overall network load levels, application 412 ensures that the same 10% difference remains after optimization. In other words, the demand in all participating networks is redistributed to eliminate high peaks and reduce overall load levels, but in a way that still maintains the initial relative 10% difference. The specific metrics to define and maintain competitive differentiation may be defined jointly among the participants. Notably, keeping the relative performance differences the same as they would be without cross optimization means that the peak load level reduction actually realized for each participant may be different from the target value requested by each participant. The relative improvement for everyone will be the same unless an agreement about wholesale and associated payments for the resulting additional improvement is in place.

Notably, in the event that the participating networks are owned by different MNOs, it is not necessary for either MNO to disclose anything about its actual network topology or structure during the planning and simulation stage. Even the serving cell identifiers can be any made-up or random numbers or strings, as long as they are consistent and unique across the dataset. This may be an important consideration in case the two networks belong to MNOs that may be competitors in providing mobile services. The modeling of each respective network can be performed by separate personnel or contractors hired by each individual MNO.

In step 750, application 412 returns modified demand maps, representing new network allocations for the modeled mobile devices on the demand maps to the planning modules 434 for each participating MNO system 430. In other words, upon completion of the cross optimization by application 412, the revised demand maps may be returned to each of the network models. In these maps, the fixed subscribers'mobile devices may have been transferred between the two networks. In some locations of the original demand map, there may now be multiple mobile devices with their respective services, and in other locations, there may not be any mobile devices. These demand maps can be fed back into the network models to simulate and examine the load distribution and other network performance parameters in this optimized mode of the network. This represents one implementation of the SAFE-R framework's post-action prediction and digital twin simulation stage of the process.

This cycle of modeling, optimization, and simulation can be repeated to find the objectives and the optimized solution that best satisfies the goals set for the participating networks. Specifically, in step 760, application 412 determines whether there are any changes to be made to the optimizations performed in steps 720-750. For example, a particular MNO may not be satisfied with the modified demand maps or achievement of the objectives, or may have changed objectives. If changes are requested (i.e., “YES” in step 760), another iteration of steps 720-750 is performed with new demand maps and/or objectives. Otherwise, if the MNOs are satisfied with the optimization (i.e., “NO” in step 760), application proceeds to step 770.

In an embodiment, application 412 also returns information to each MNO system 430 about the predicted user experience metrics for all of its mobile devices, including the mobile devices that will be connected to other networks following optimization. This gives each MNO the complete predicted experience of all of its subscribers.

After the optimization, there will be a new demand map for each of the networks A and B. In step 770, based on these demand maps and the established need for transferring mobile devices from one network to the other network in each of the partial overlap areas, as illustrated in FIGS. 9A and 9B, the network parameters for accomplishing the desired transfers can be calculated. In an embodiment, the CIOs are utilized to select which mobile devices from each partial overlap area in one network are transferred to the other network. This selection process is described in more detail elsewhere herein. These parameter values represent candidate actions that in the SAFE-R framework are still subject to readiness, prediction, and guardrail validation before publishing.

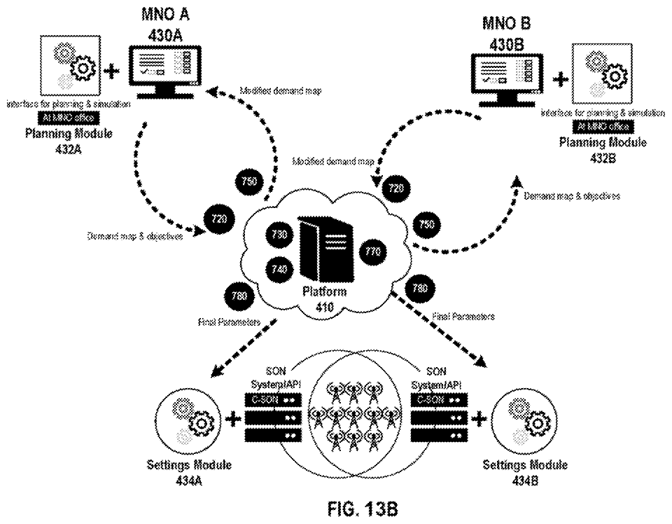

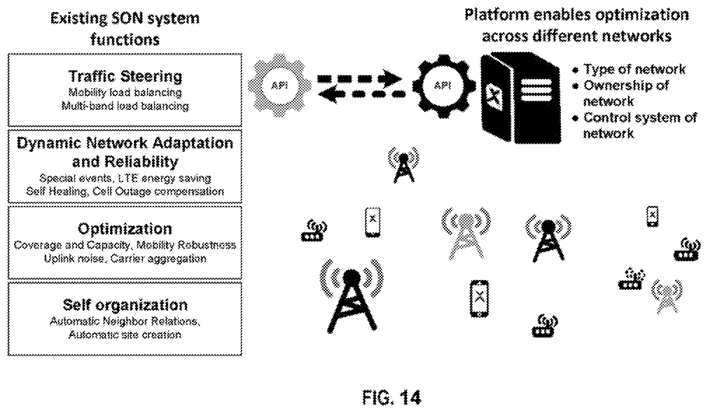

In step 780, application 412 delivers the necessary demand transfer parameters for controlling the network to settings modules 434 of the MNO system 130 of each participating MNO, to be used in the real-time operation of their networks. In an embodiment, the implementation of these parameters in the real-time operation of the networks is accomplished through SON systems, which already handle similar parameters for management and optimization within each network separately. In other words, application 412 may deliver the demand transfer parameters through an API of a SON system, as illustrated in FIG. 14, according to an embodiment. Notably, the functions of platform 410 extend into the current SON systems and the existing network control systems, in networks that are within its scope of optimization, by adding or changing the parameters that these systems use. Such parameter delivery or publication to the appropriate interfaces will be in the SAFE-R framework completed only if this publication satisfies safety, policy, confidence, and rollback-aware constraints.

As discussed above, many mobile network control systems already have sophisticated internal load-balancing mechanisms. One example is the network-control mechanism described in the 3GPP (ETSI) standard for cellular networks. Additional optimization functions are available in the various SON systems. Platform 410 takes advantage of these existing widely deployed mechanisms and adds a layer of optimization that may include trade-offs of value across boundaries between networks and sets of mobile devices. This added layer of optimization may also be extended to actual commerce and trading of access to network resources or local data transfer capacity between network and mobile service providers.

The cross optimization of platform 410 also introduces a different time domain and scope to the network control and management, as illustrated in FIG. 11. Considering the ability to use different profiles that are based on averages of demand patterns measured over several occurrences of regularly occurring events, this cross optimization can be characterized as applying broad-based optimization control to the “harmonics” of the variations in demand patterns. On one level, the periodic (e.g., weekly or monthly) recalculation based on averages implements a feedback loop control system through the planning modules 432 and cross-optimization calculation that has, for example, weeks as its typical time constants. On another level, the switching to relevant profiles based on predictable occurrences of various situations provides the ability to exercise long-term control on different events that may occur on the time scale of hours or less and a repeat pattern of days, weeks, or at other predictable or detectable times.

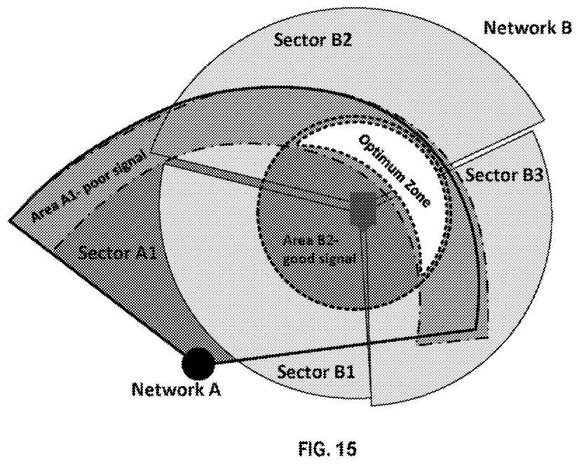

Objectives for optimum selection of roaming devices, when seeking to balance load across cells in the most economical way, will now be discussed. FIG. 15 illustrates the detailed situation in two overlapping networks A and B, according to an embodiment. For the purposes of discussion, it is assumed that the load in cell A1 is higher than desirable, such that the user experience of mobile devices connected to cell A1 has deteriorated. User experience and the average data transfer speed in a cell depends on the average load level. The higher the load level, the lower the average speeds. In this sense, there is “value” to decreasing the load in cell A1, since the average user experience will improve. A monetary manifestation of this value can be seen in the network capacity upgrade investments made by the mobile service providers that operate and maintain their own networks.

Speed and user experience are worst at the edge of cell A1 in area A1, since mobile devices in this area have the poorest signal. As mentioned earlier, the distance of a mobile device from the cell site is being used to indicate the quality (throughput) of a connection, which in the real world is closely related to physical distance. Notably, devices in area A1 are also the most “expensive” to serve in terms of network resources, since they have slower connections and getting the same amount of data to them takes up a higher amount of time and network resource blocks than devices that are in good signal conditions. The difference in an LTE network can be up to fifty-fold, and in many network implementations is routinely more than twenty-fold between the center and edge of a cell. When multiple input, multiple output (MIMO) is used, the difference may be even higher. Thus, removing the load of mobile devices in area A1 would provide the most effective relief of the load in cell A1, because the data needs of these mobile devices are the most “expensive” to satisfy in terms of radio resources. In other words, these mobile devices consume more resource blocks per megabyte of data transfer.

The illustration in FIG. 15 simplifies the situation for purposes of clarity by assuming that the signal quality- and, therefore, the data transmission efficiency-depends only on the distance from the antenna. In reality, other factors, such as the terrain, buildings, the specific location of the mobile device, the antenna, and the radio frequency (RF) front end of the mobile device, have an impact on the signal quality (e.g., the signal-to-noise ratio). Therefore, it should be understood that, in reality, the area A1, representing the poor signal quality in network A, is determined by the actual signal quality, rather than simply the distance from the antenna.

As illustrated in FIG. 15, network B comprises three cells B1, B2 and B3. Considering that the signal fades with distance, there will be a good signal area in the vicinity of the cell antennas. This is shown in FIG. 15 as area B2. In accordance with the simplified manner of illustration, area B2 is approximately a circle with the cell antenna located in the center of the circle. This assumes that the transmission powers and antennas and their tilt angles in each of cells B1-B3 are identical. Again, it should be understood that, in reality, the area B2, representing the good signal quality in network B, is determined by the actual signal quality, rather than simply the distance from the antenna. This good signal area B2 represents the part of the cells B1-B3 in which the efficiency of serving mobile devices is at its highest. A good signal corresponds to better encoding and faster speeds with fewer resource blocks (in LTE protocol) needed to provide a given amount of data transmission.

Considering a situation in which cell A1 is at a load level that is higher than desirable and cells B1-B3 are at load levels at which additional load would not cause an unacceptable decline in user experience, it would be desirable to move the connections and thereby the associated load of some mobile devices in cell A1 to cells B1-B3. To be more precise than just referring to a “higher than desirable” load or an “acceptable decline,” there is a value and a cost associated with every incremental change in load. There is a complex non-linear relationship between load and network performance, and the value of incremental speed is also non-linear.

Usually, the service of a mobile device, whose “home” is on network A, on a “visited” network B is done for coverage reasons (e.g., when network A cannot provide an acceptable signal). In this case, it is said that the mobile device “roams” on network B. Roaming is done for load balancing and for the purpose of using existing resources more efficiently. Roaming between networks that belong to different MNOs may sometimes be referred to as “economic roaming.”

Considering the specific resource efficiency described above, it can be concluded that the most resource-economical way of achieving the load reduction in cell A1 (and creating value) would be to move some of the mobile devices with a poor signal in area A1 away from cell A1, and allow those devices to be served by network B. This would create the maximum load reduction (and value) in relation to the number of transferred connections and total data demand served by network B.

To further optimize this scenario, the subset of mobile devices to be transferred from network A to network B should be those mobile devices that can have a good signal on network B. This would result in the absorption of the additional data transfer need with the minimum increase of resource load (cost) in network B, since the demand from mobile devices with a better signal can be served with fewer resources. As can be seen in FIG. 15, this would be the mobile devices in the area that is an intersection of areas A1 and B2. This area is labeled “Optimum Zone” in FIG. 15.

It is possible for cells B1-B3 to have different load levels. Therefore, the incremental load from mobile devices coming from network A may have a different effect on the user experience in each of cells B1-B3. This can be thought of as a different “cost” for the target. Cost in this context can be thought of as an adverse effect on the users of mobile devices in network B, since most of the actual cost of the networks and their operations are fixed costs that are not affected by the load. In this case, the optimal distribution of mobile devices from network A in area A1, between cells B2 and B3, would be different. The signal level in network B, at which it would be best to receive a roaming device from area A1, would also be different for cells B2 and B3. It is even possible that cell B1 would be the best cell to receive some of the mobile devices in cell A1, if the load in cell B1 is much smaller than the loads in cells B2 and B3. As used herein, the term “signal level” can mean any available signal parameter that indicates the quality or strength of the connection that can be achieved. Examples of such signal parameters include, without limitation, signal-to-noise ratio (SNR), signal-to-interference-plus-noise ratio (SINR), channel quality indicator (CQI), reference signal received quality (RSRQ), reference signal received power (RSRP), and received signal strength indicator (RSSI).

As discussed above, the concepts of cost and value, in the sense of a change in the network speed experienced by mobile device users, have direct financial counterparts. This is evidenced by the network investments made to maintain acceptable load levels in wireless networks. In reality, the relation of network load reduction, through cross optimization, to the actual financial value is quite complex. First, the relationship of network load to the average speed experienced by mobile devices is non-linear and complicated. Therefore, the value of incremental changes inherently depends on the existing load levels. Second, economic roaming can be seen as an alternative to a network capacity upgrade. The cost of the upgrade depends on a number of factors, such as the availability of additional spectrum, local factors like availability of cell sites and cost of backhaul, and/or the like. Furthermore, the value of maintaining a good user experience may vary across different network user groups or locations.

As pointed out, the method described here can be used to manage better the distribution of demand and mobile devices between network layers of different frequencies in a single network. Currently prevalent methods utilize a strategy where fixed absolute frequency layer priorities set for idle mode network reselection are the primary factor. The devices will select the network layer with the highest priority level and will not even measure the signal conditions in other layers unless the measured signal level falls below a set level called the ThresXhigh.

This lends itself to a simple method to set the parameters, but wastes network capacity and can result in suboptimal use of resources. Often the metric used to measure the success of the parameter settings is the average speed (throughput) of all cells in a network cluster (typically hundreds of cells and dozens of cell sites). High average throughput can be achieved by tuning the network so that many cells achieve extremely high speeds. They are not of any value to end users, since they do not improve the user experience much. However, the super high speeds outweigh poor performance in smaller number of cells that may have really poor connection speed and the average network speed may be higher even though many cells are performing poorly.

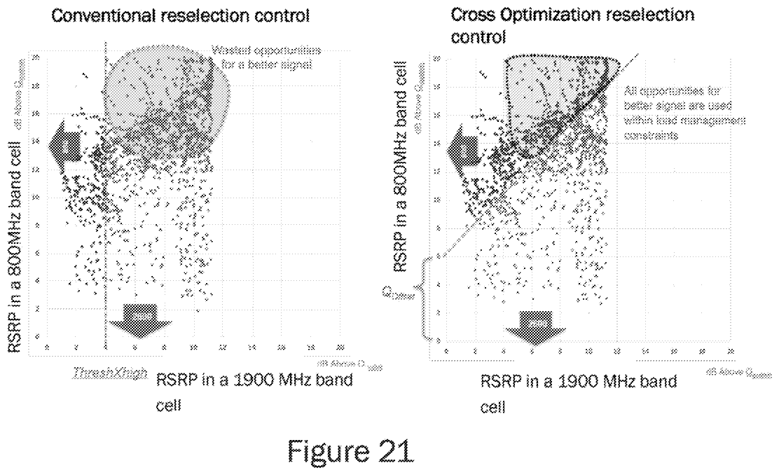

The method described here provides much greater and more granular control to utilize the network resources so that speed distribution is more even. It employs equal network layer priorities and increases the sNonIntraSearch parameter values resulting in more comparison measurements between serving and target cells. Without any other changes in the parameters, most devices would gravitate to the cells with best signal strength regardless of its bandwidth, load or interference and noise levels. Therefore, other parameters need to be set to manage the distribution of load between cells. These include the qOffsetFreq and qOffsetCell to manage load and optimize speed distribution of connected devices in a cluster of many cells in different frequency layers. The difference between the conventional control method and the Cross Optimization method is illustrated in FIG. 21.

In real time reselection the comparisons between cells are based solely on readily available signal strength or signal power measurements. However, the actual connection speed (throughput) depends on the actual signal to noise and interference ratio and is also modified by the bandwidth of the connection and the load percentage (PRB occupation) of the serving cell.

To optimize the selection for throughput the cross optimization method applies a set of correction factors to the comparison measurement when setting the qOffset values.

For bandwidth differences generally doubling the bandwidth doubles the speed. Also a 3 dB difference in the actual SINR value doubles the speed. This provides an approximation of the bandwidth correction factor.

Since it is not practical to measure the actual SINR values and current standards use the RSRQ measurement only as a “second level check” on selections based on RSRP, the current method also applies a correction factor to adjust for different levels of noise and interference in different parts of the networks, different layers, cells and different locations.

For example, the correction factor may be based on the difference in the RSRP and SINR measurements between two cells at frequency layer or in a particular location. These differences can be estimated in several different ways: They can be derived from network modeling simulations calibrated by field data, or be based on virtual or real drive test data. They can also be obtained from crowdsourced device data where connected devices report their location, cell connection and measurements of the relevant parameter values into a database that can be used to estimate the parameters.

In an optional embodiment of the solution described herein the distribution of connected devices in the coverage area of a cell is determined based on time of arrival (TOA or OTDoA) information from several cells in one or more frequency layers. This information can be used to determine the number of users that would be affected by a change in the network parameters.

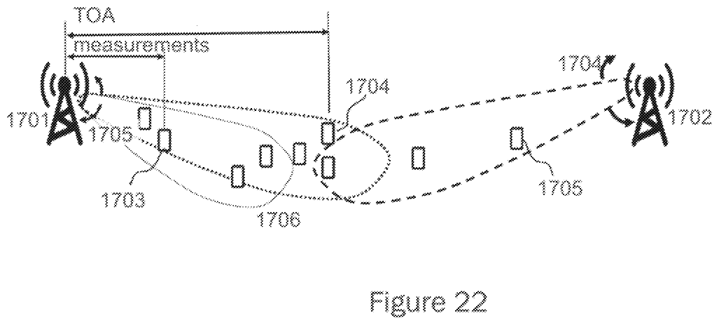

In an optional embodiment, addition to or instead of the cell reselection or handover threshold parameters, the network parameters that will be adjusted can also be the antenna tilt parameters at the base stations in the network. FIG. 22 illustrates the use of TOA measurements and the effect of antenna tilt on the coverage pattern.

Base stations 1701 and 1702 are serving connected devices 1703,1704 and 1705 and others. TOA measurements can estimate the distance of a connected device from the base station. For example it would indicate that device 1704 is much farther than device 1703 from its base station 1701.

Each base station can adjust the vertical tilt of the antennas and thereby alter the coverage pattern and the distribution of signal strength on the ground as is illustrated for antenna of base station 1701 tilt changing the pattern 1706 illustrated in FIG. 22 with dotted lines. By performing antenna tilt changes in multiple base stations both the signal and interference levels for connected devices can be adjusted. This will affect the throughput of the device and will also have an effect on the serving cell reselection depending on the settings of the reselection parameters qOffsetFreq and qOffsetCell and sNonIntraSearch. In this optional embodiment, the kernel based optimization process is performed after the initial distribution of devices in various cells is first adjusted by using the TOA method.

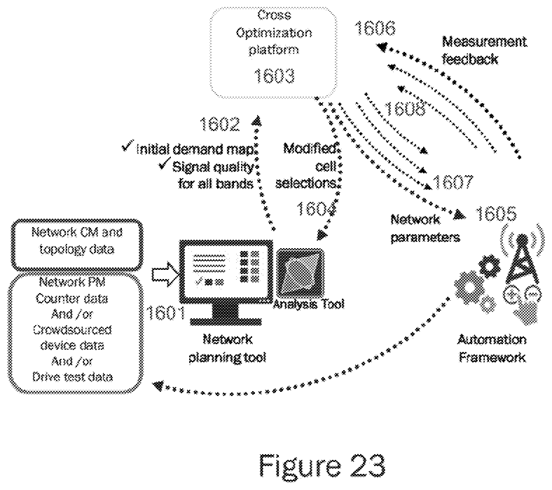

As illustrated in FIG. 23, network configuration, performance-management, crowdsourced-device, drive-test, topology, and signal-quality information may be provided to a network planning tool 1601 and a cross-optimization platform 1603 as input information 1602. The network planning tool 1601 and cross-optimization platform 1603 may generate modified cell selections or other candidate network-control actions 1604.

The candidate network-control actions may be evaluated using a network model, simulation model, digital twin, state-transition model, Markov model, or combinations thereof. Candidate actions satisfying applicable readiness, prediction, utility, and guardrail criteria may be provided as network parameters 1607 to an automation framework 1605 for approval, scheduling, or implementation.

Measurement feedback 1606 may be returned to the cross-optimization platform 1603 after implementation. Additional feedback 1608 may include observed load, throughput, mobility quality, handover performance, signaling load, user experience, or other performance information.

The observed performance may be compared with predicted performance. If a rollback condition is satisfied, the automation framework may reverse, reduce, suspend, or replace a parameter change. Otherwise, the parameter settings may be maintained or used as the basis for a subsequent adjustment.

Observed outcomes may be stored and used to update readiness models, prediction models, action-evaluation models, guardrails, rollback thresholds, recognized-context profiles, demand profiles, or historical outcome records.

The iteration of thousands of small changes in network parameters over time and various conditions and measuring the resulting performance improvements generates a rich set of detailed data, which in one embodiment is used as a basis for machine learning and model updating, which will be able to improve the setting of the network parameters based on the learning.

### 20. Controlling Network Selection of Mobile Devices

In an embodiment, the mechanics of a connection transfer, resulting from cross optimization, can be thought of as an extension to the set of normal handovers that take place when mobile devices move though an area covered by several cells, or when the load needs to be balanced between different parts of the network across RAT boundaries or frequency-band boundaries. The parameters for the handovers may be adjusted, according to the cross optimization by application 412, by adding specific changes to the handover instruction parameters used in normal network operations.

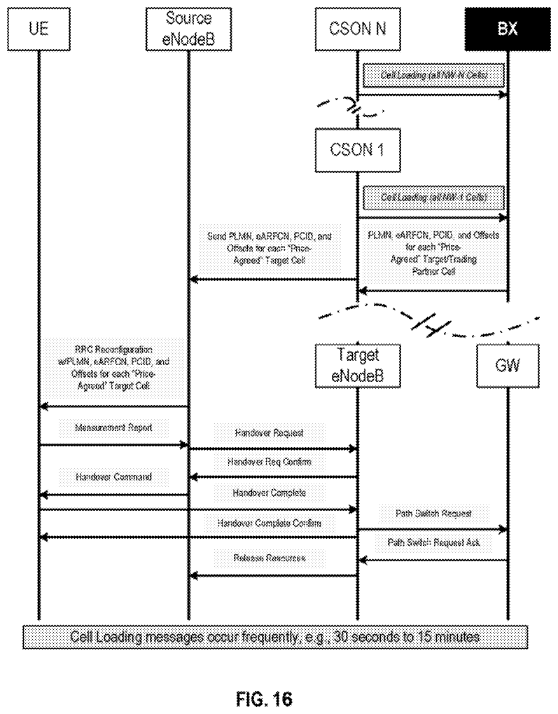

FIG. 16 illustrates an example of a call flow in a network handover scenario, along with the key interfaces and actions that the cross optimization utilizes to achieve the optimum load distribution across two separate networks, according to an embodiment. The disclosed system has the ability to alter typical single-network handovers to support multi-network handovers by monitoring the network load and performance at the cell level. These parameter changes, initiated by platform 410 (e.g., via delivery in step 780), may include, without limitation, measurement offsets and system and cell identification information of the other network (or layer) that participates in the cross optimization. Control parameters include, for example, sector/cell loading, commonly represented by PRB occupation or transmission time interval (TTI) utilization.

In an embodiment, the parameter changes may be implemented via an interface with SON equipment. Alternatively, platform 410 process may communicate directly with the network management systems of the participating networks or the entities which contain loading information for the participating networks. In either case, an interface (e.g., settings module 434) for providing the parameter changes is provided between application 412 and the SON equipment or other network management system.

In the embodiment in which platform 410 is interfaced to SON equipment, application 412 may utilize a specific application programming interface (API) and function as a “plug-in” piece of software which provides additional functionality to the SON systems of each participating network. This API enables application 412 to receive loading information and other key performance indicators (KPI) from participating networks. In this case, platform 410 would directly interface with SON equipment.

### 21. Example Implementation

In an environment in which platform 410 is connected to two or more LTE networks, the participating networks would offer their loading information in frequent intervals to application 412. As discussed elsewhere herein, application 412 may be located in a data center (e.g., in the Cloud). Alternatively, application 412 may at least be partially located in one or more of the MNOs'premises (e.g., application 412 may comprise both server-side and client-side modules). This loading information is input to application 412, which processes the loading information from the plurality of networks, to produce a result. The result of the algorithms of application 412 is a parameter change instruction (e.g., step 780) that will go to the native network cells. The parameter changes may comprise, without limitation, Public Land Mobile Network (PLMN) code (e.g., a combination of the Mobile Country Code (MCC) and Mobile Network Code (MNC), which uniquely identifies the Mobile Network Operator), and Physical Cell Identity (PCID), which identifies a cell, or Global Cell Identity (CGI) of the partner network, as well as CIOs for the new neighbors (e.g., via a Radio Resource Control (RRC) Reconfiguration message and/or various System Information Blocks (SIBs)). The parameter changes may also include changes in the A3-offset cell and event A2 thresholds. The parameter changes may also include hysteresis, filter coefficients, time to trigger, and/or other handover parameters.

In a real mobile network, mobile devices move around, and individual connection parameters change over time. Also, load levels and data demands change with time. To provide an opportunity to constantly adjust the optimization, regarding which mobile devices are connected to the primary or home network or various cells of the visited network(s), a mechanism may be provided to steadily return a stream of mobile devices from the visited networks back to the primary network. This way, there will be a continuous stream of optimization decisions regarding the transfer of connections to the visited network(s), and these decisions will take into account the changing parameters. Since the load conditions are measured frequently (by the SON system or network management system) and these updated parameters are used in making subsequent transfer decisions and parameter adjustments, there is a feedback loop from the effects of optimization to new optimization actions. This provides stability, and facilitates the objectives of platform 410.

Some of the parameters in the RRC reconfiguration messages sent to mobile devices entering each cell in a mobile network are used for intra-network handover management, and can be adjusted by a SON system to do automatic load balancing between neighboring cells. Therefore, it is important that any changes to these parameters, made by application 412, are made in a way that does not adversely affect these functions. Of course, the parameters relating to the cells in network B are not used for any purpose other than managing intra-network traffic. Therefore, application 412 can set these parameters without being concerned about affecting internal functions of network A.

The offset parameters for new cells in network B should be included in the first messages to mobile devices in network A entering overlap areas. For example, normally including the PLMN and the PCID of cell B1 without any offset values would result in a number of mobile devices from cell A1 initiating handovers to cell B1 instead of other neighboring cells in network A. This is because the signal strengths close to the cell site of cell B1 in network B may be much higher than the signal levels in the cells of network A that neighbor cell A1. Normally, a handover process is initiated when the signal of the serving cell drops below the signal in the neighboring cell, wherein both signals are adjusted using the offsets (i.e., the A3 offset and the CIO for the neighboring cell).

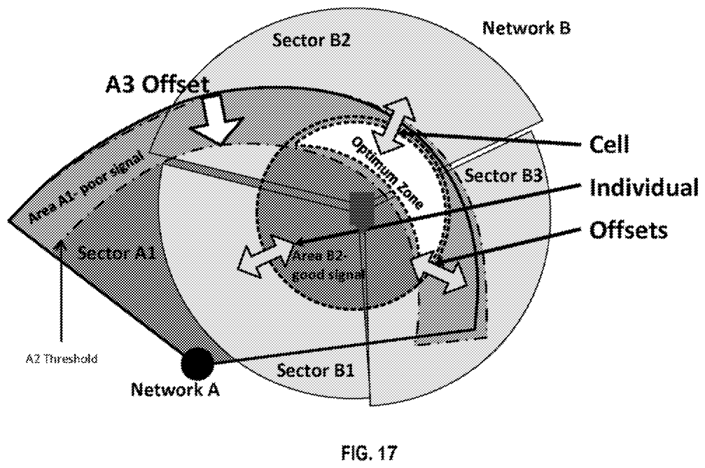

By including a large negative offset as the CIO for all of the cells in network B that are included in the updated configuration message transmitted by network A, the number of handovers initiated from network A to network B can be limited. It may be possible to also control the number of handovers by setting the so-called Event A2 and A1 thresholds. Setting these thresholds can limit the number of devices that engage in the measurement and signal comparison for handover initiation purposes in the first place. FIG. 17 illustrates the various thresholds and offsets, using the example from FIG. 15.

When the CIOs of cells in network B are adjusted up from the initially high negative value (e.g., for LTE the CIO range is −24 dB to +24 dB), the number of mobile devices for which the offset-adjusted signal level comparison triggers a handover to network B will increase. By controlling these CIOs, application 412 can control the amount of traffic that will be moved from each cell in network A to each cell in network B.

Additionally, in the event that the target traffic amount is not achieved by just setting the CIOs for the cells in network B, it is possible to also adjust the so-called trigger parameter A3 offset. The A3 offset is normally set at a level at which only mobile devices with a poor signal, close to the edge of the cell, will trigger measurement report messages for a handover to a different cell. This is what essentially defines the cell edge in FIG. 15. If there is a need to change the number of mobile devices transferring to network B, application 412 can also change the A3 offset (e.g., in step 770). A negative change (i.e., lowering the A3 offset) would increase the number of mobile devices for which the signal level comparison will trigger a transfer. A positive change (i.e., increasing the A3 offset) would reduce the number of mobile devices for which the signal level comparison will trigger a transfer. This may be desirable, for example, in instance in which the maximum negative offset in the CIOs of network B still results in more handovers than desired. In order to keep changes in the A3 offset from affecting internal handovers in network A (i.e., handovers between neighboring cells in network A), the CIOs for neighboring cells in network A should be changed by the same amount. This leaves the relative values unchanged, such that intra-network handovers will not be affected.

FIG. 17 illustrates the effect of the A3 offset and the incremental changes in the CIOs, using the same graphical representation for signal quality discussed in conjunction with FIG. 15. The result of these incremental parameter changes is that some devices will initiate the handover procedure from cell A1 to cell B1 or B2 by sending measurement report messages to network A. This sets off the process described in FIG. 16. The target cells still have an opportunity to decline the handover request. However, normally the declination mechanism is not needed, since the number of mobile devices transferring between networks is controlled by adjusting the parameters that initiate the handovers.

As mobile devices execute the handover procedure, the load in cell A1 will decrease, and the load in cells B1 and B2 will increase. Notably, the demand- and therefore, the load leaving cell A1 comes from an area in cell A1 with a poor signal. After the handover is complete, this same demand is subsequently served by a stronger signal in cells B1 and B2. This causes an increase in load on cells B1 and B2. However, simulation has shown that this increase in load on cells B1 and B2 is significantly less than the load caused by the mobile devices in the area of poor signal in cell A1. Therefore, the load decrease in cell A1 is greater than the total load increase in cells B1 and B2, when considered in terms of network resources (e.g., PRBs needed to satisfy the load in LTE networks). This is a very desirable characteristic of the disclosed mechanism, both in terms of efficient usage of resources and improvement in user experiences.

In an embodiment, the cross optimization uses the 3GPP standard's control handover events: Event A3 and Event A5. Event A3 is two measurements compared to each other, and Event A5 is two measurements compared to fixed thresholds. In accordance with the standard, CIOs are used to bias the measurement reports that are sent to the eNodeB by mobile devices. These reports trigger the initiation of handovers. CIOs can be used similarly for both Event A3 and Event A5.

Reference Signal Received Quality (RSRQ) and Reference Signal Received Power (RSRP) can be used for Event A3, according to LTE standards. In an embodiment, the cross optimization uses the RSRQ for Event A3, and optionally RSRP for Event A5. Application 412 calculates which cell pairs are appropriate for accomplishing performance objectives, and adds the appropriate overlapping cells to the neighbor list of a cell via the RRC Connection Reconfiguration message. For these new neighbor cells, application 412 sets the CIO values to ensure the intended portion of the demand will be transferred as a result of the handovers that take place. The CIOs added to handover parameters are specific to a cell pair, consisting of one cell in each network or frequency layer. For each cell in one network, there can be a calculated CIO for each of the overlapping cells in the other network. This is illustrated in FIG. 18.

Cell A1 in network A overlaps with four cells, B1-B4, in network B. In this scenario, assuming that cell A1 is overloaded, the cross optimization of application 412 would likely move some mobile devices from cell A1 to at least some of cells B1, B2, and B3. The amount of traffic to move depends on the load (PRB occupation) levels in each of the cells. Assuming that cells B2 and B3 are underutilized, they would be added to the neighbor list for mobile devices in handover areas 1210 in cell A1. Handover areas 1210 are at the edge of cell A1. Thus, typically, signal quality will be weak in handover areas 1210, as compared to signal quality available from cells B2 and B3 in handover areas 1210. To accomplish the handovers in handover areas 1210, a relatively large negative bias, in the form of A3 CIO parameters for cell A1, could be set towards each of cells B2 and B3. Selection of the A3 CIO parameter for one or more cells in network B will regulate the amount of demand transfer. In this case, it would cause mobile devices in handover areas 1210 to be transferred to the new neighbor cells B2 or B3. The user experience for these mobile devices should improve for two reasons: they will get a better SINR; and they will be served by a cell with a lower load.

The LTE standard specifies the entering condition for Event A3 as:

Mn+Ofn+Ocn−Hys>Mp+Ofp+Ocp+Off
wherein Mn is the measurement of the neighboring cell,
wherein Ofn is the offset for frequency of the neighboring cell being measured,
wherein Ocn is the CIO for the neighboring cell being measured,
wherein Hys is the hysteresis parameter for this event,
wherein Mp is the measurement of the primary (i.e., serving) cell,
wherein Ofp is the offset for the frequency of the primary cell,
wherein Ocp is the CIO for the primary cell, and
wherein Off is the A3 offset parameter.

Typically, Hys and Off are global or event-specific values that are optimized and set by the MNO of the primary network. Assuming that Ofn, Ofp, Ocp, Hys, and Off are all set to zero, the entering condition for Event A3 reduces to:

Mn+Ocn>Mp

The CIO parameter, Ocn, is specific to a pair of cells, defined by Mn and Mp. In an embodiment, this standardized ability to modify and add precise pairs of biased cells, to invoke a measurement report message, is the mechanism that introduces the disclosed cross optimization into real-time operations. Mn and Mp define the precise pair of cells, and the Ocn parameter defines the calculated bias for that pair of cells. The pair of cells typically consists of two cells belonging to different networks (e.g., one “home” network cell, and one “visited” network cell of a partner network). The system-calculated CIO values are unique to each specific pair of cells. In cells where no demand transfer is required, no new neighbor cells are added.

With the disclosed cross optimization, device throughput will improve on the home network, because mobile devices will transfer to a cell offering a better combination of signal strength and load. The improved throughput will also result in an improved user experience by the users of the mobile devices subscribed to the home network.

Similar to the use of the Event A3 CIO parameters described above, the cross optimization may optionally use the Event A5, in order to increase coverage reliability by moving mobile devices with weak signals in the home network to a stronger signal in the visited network. Since Event A5 is based on absolute RSRP measurements, the result is improved reliability, coverage, and user experience.

The LTE standard specifies the entering condition for Event A5 as:

Mp+Hys<Thresh1
and

Mn+Ofn+Ocn-Hys>Thresh2
wherein Mp is the measurement of the primary (i.e., serving) cell,
wherein Hys is the hysteresis parameter for this event,
wherein Thresh1 is a threshold parameter of the primary cell for this event,
wherein Mn is the measurement of the neighboring cell,
wherein Ofn is the offset for frequency of the neighboring cell being measured,
wherein Ocn is the CIO for the neighboring cell being measured, and
wherein Thresh2 is a threshold parameter of the neighboring cell for this event.
Typically, Hys, Thresh1, and Thresh2 are global or event-specific values that are optimized and set by the MNO of the primary network. Assuming that Ofn and Hys are set to zero, the entering condition for Event A5 reduces to:

Mp<thresh1

and

Mn+ocn>thresh2

Similar to Event A3, the CIO parameter, Ocn, is specific to the neighboring cell being measured, and can be used to ensure that the A5 Event is triggered only when a transfer to the neighboring cell will increase the RSRP.

### 22. Transporting Demand

In an embodiment, platform 410 offers a mechanism to transport mobile demand—and therefore, capacity—over long distances. This can be very useful, for example, when the implementation area includes both residential and commercial areas, since the peak load patterns for these two types of areas are counter-cyclical, as shown in FIG. 12.

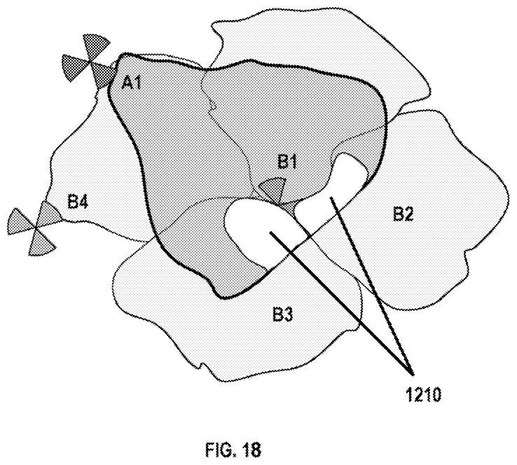

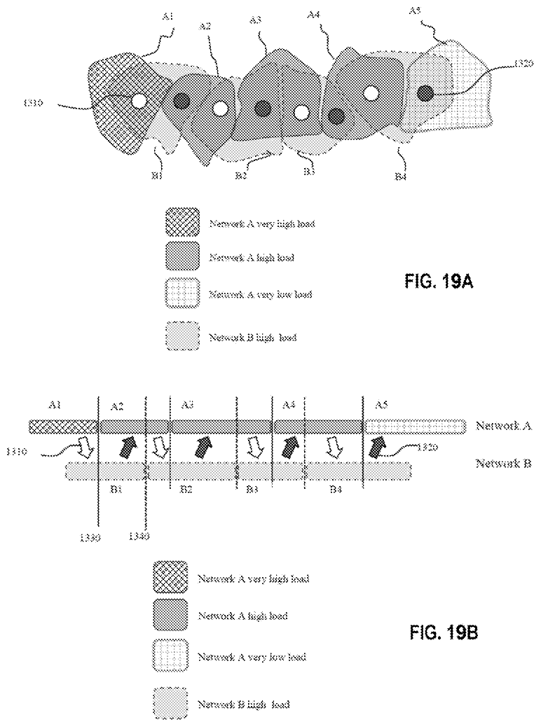

FIGS. 19A and 19B illustrate how mobile demand is transferred over a long distance from one area (e.g., commercial area) to another area (e.g., residential area), according to an embodiment. FIG. 19A illustrates a top view of a plurality of cells spread over a geographical area. Network A comprises a set of adjacent cells A1-A5, and network B comprises a set of adjacent cells B1-B4. Assume that cell A1 (e.g., a commercial area during the workday) has a very high load percentage, and needs to transfer demand away. Cells A2-A4 all have a high load, and therefore, are not in a position to add net load from other cells. However, cell A5 (e.g., a residential area during the workday) has a very low load, and therefore, is not being effectively utilized. Network B has overlapping coverage to network A. Specifically, as illustrated, cells B1-B4, overlap network A. However, all of these cells in network B have a high load. Therefore, network B cannot take on additional net load from network A. Consequently, in this illustrated example, the only cell capable of accepting additional load is cell A5.

FIG. 19B illustrates a side view of the same plurality of cells illustrated in FIG. 19A. The boundaries between adjacent cells in network A are illustrated by solid lines 1330, and the boundaries between adjacent cells in network B are illustrated by broken lines 1340. These lines also illustrate the projection of these boundaries to cells in the other network.

In an embodiment, demand is transferred from network A to an overlapping cell in network B in each of the areas indicated by light dots 1310 in FIG. 19A and light arrows in FIG. 19B. Contemporaneously, demand is transferred from network B to an overlapping cell in network A in each of the areas indicated by dark dots 1320 in FIG. 19A and dark arrows in FIG. 19B. If the corresponding load contributions in all of these transfers are the same, the net effect is that the load level in cells A2-A4 and B1-B4 will remain the same, while the very high load in cell A1 will have been reduced and the very low load in cell A5 will have been increased. This “ripple effect” of shifting demand between different networks in the overlap areas on the edges of cells can be used to transport or “hop” demand or capacity over long geographic distances.

In actual network situations, partial overlaps extend across the entire networks. The partial overlap is especially effective between networks of two independent MNOs, but can also exist between frequency bands in a single network. Thus, while an actual partial overlap between single frequency bands in two separate MNOs networks is illustrated in FIGS. 19A and 19B, it should be understood that the ripple effect may similarly be applied to a plurality of network layers in a single network. In addition, across these networks or network layers, the ripple effect can propagate in multiple directions at the same time.

### 23. Example Processing Device

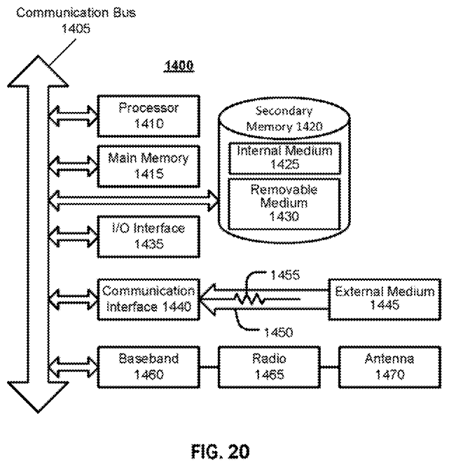

FIG. 20 is a block diagram illustrating an example wired or wireless system 1400 that may be used in connection with various embodiments described herein. For example, system 1400 may be used as or in conjunction with one or more of the functions, processes, or methods (e.g., to store and/or execute application 412, planning module 432, settings module 434, or one or more other software modules) described herein, and may represent components of any processing devices described herein, including platform 410, MNO system 430, and the mobile devices. System 1400 can be a server or any conventional personal computer, or any other processor-enabled device that is capable of wired or wireless data communication. Other computer systems and/or architectures may be also used, as will be clear to those skilled in the art.

System 1400 preferably includes one or more processors, such as processor 1410. Additional processors may be provided, such as an auxiliary processor to manage input/output, an auxiliary processor to perform floating-point mathematical operations, a special-purpose microprocessor having an architecture suitable for fast execution of signal-processing algorithms (e.g., digital-signal processor), a slave processor subordinate to the main processing system (e.g., back-end processor), an additional microprocessor or controller for dual or multiple processor systems, and/or a coprocessor. Such auxiliary processors may be discrete processors or may be integrated with processor 1410. Examples of processors which may be used with system 1400 include, without limitation, the Pentium® processor, Core i7® processor, and Xeon® processor, all of which are available from Intel Corporation of Santa Clara, California.

Processor 1410 is preferably connected to a communication bus 1405. Communication bus 1405 may include a data channel for facilitating information transfer between storage and other peripheral components of system 1400. Furthermore, communication bus 1405 may provide a set of signals used for communication with processor 1410, including a data bus, address bus, and/or control bus (not shown). Communication bus 1405 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 1400 preferably includes a main memory 1415 and may also include a secondary memory 1420. Main memory 1415 provides storage of instructions and data for programs executing on processor 1410, such as one or more of the functions and/or modules discussed herein. It should be understood that programs stored in the memory and executed by processor 1410 may be written and/or compiled according to any suitable language, including without limitation C/C++, Java, JavaScript, Perl, Visual Basic, . NET, and the like. Main memory 1415 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 1420 may optionally include an internal medium 1425 and/or a removable medium 1430. Removable medium 1430 is read from and/or written to in any well-known manner. Removable storage medium 1430 may be, for example, a magnetic tape drive, a compact disc (CD) drive, a digital versatile disc (DVD) drive, other optical drive, a flash memory drive, and/or the like.

Secondary memory 1420 is a non-transitory computer-readable medium having computer-executable code (e.g., disclosed software modules) and/or other data stored thereon. The computer software or data stored on secondary memory 1420 is read into main memory 1415 for execution by processor 1410.

In alternative embodiments, secondary memory 1420 may include other similar means for allowing computer programs or other data or instructions to be loaded into system 1400. Such means may include, for example, a communication interface 1440, which allows software and data to be transferred from external storage medium 1445 to system 1400. Examples of external storage medium 1445 may include an external hard disk drive, an external optical drive, an external magneto-optical drive, and/or the like. Other examples of secondary memory 1420 may include semiconductor-based memory, such as programmable read-only memory (PROM), erasable programmable read-only memory (EPROM), electrically erasable read-only memory (EEPROM), and flash memory (block-oriented memory similar to EEPROM).

As mentioned above, system 1400 may include a communication interface 1440. Communication interface 1440 allows software and data to be transferred between system 1400 and external devices (e.g. printers), networks, or other information sources. For example, computer software or executable code may be transferred to system 1400 from a network server (e.g., platform 110) via communication interface 1440. Examples of communication interface 1440 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 1400 with a network (e.g., network(s) 120) or another computing device. Communication interface 1440 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 1440 are generally in the form of electrical communication signals 1455. These signals 1455 may be provided to communication interface 1440 via a communication channel 1450. In an embodiment, communication channel 1450 may be a wired or wireless network (e.g., network(s) 120), or any variety of other communication links. Communication channel 1450 carries signals 1455 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (e.g., computer programs, such as disclosed application 412 or other software modules) is stored in main memory 1415 and/or secondary memory 1420. Computer programs can also be received via communication interface 1440 and stored in main memory 1415 and/or secondary memory 1420. Such computer programs, when executed, enable system 1400 to perform the various functions of the disclosed embodiments as described elsewhere herein.

In this description, the term “computer-readable medium” is used to refer to any non-transitory computer-readable storage media used to provide computer-executable code and/or other data to or within system 1400. Examples of such media include main memory 1415, secondary memory 1420 (including internal memory 1425, removable medium 1430, and external storage medium 1445), and any peripheral device communicatively coupled with communication interface 1440 (including a network information server or other network device). These non-transitory computer-readable media are means for providing executable code, programming instructions, software, and/or other data to system 1400.

In an embodiment that is implemented using software, the software may be stored on a computer-readable medium and loaded into system 1400 by way of removable medium 1430, I/O interface 1435, or communication interface 1440. In such an embodiment, the software is loaded into system 1400 in the form of electrical communication signals 1455. The software, when executed by processor 1410, preferably causes processor 1410 to perform one or more of the processes and functions described elsewhere herein.

In an embodiment, I/O interface 1435 provides an interface between one or more components of system 1400 and one or more input and/or output devices. Example input devices include, without limitation, sensors, keyboards, touch screens or other touch-sensitive devices, biometric sensing devices, computer mice, trackballs, pen-based pointing devices, and/or the like. Examples of output devices include, without limitation, other processing devices, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch panel display (e.g., in a smartphone, tablet, or other mobile device).

System 1400 may also include optional wireless communication components that facilitate wireless communication over a voice network and/or a data network (e.g., in the case of user system 130). The wireless communication components comprise an antenna system 1470, a radio system 1465, and a baseband system 1460. In system 1400, radio frequency (RF) signals are transmitted and received over the air by antenna system 1470 under the management of radio system 1465.

In an embodiment, antenna system 1470 may comprise one or more antennae and one or more multiplexors (not shown) that perform a switching function to provide antenna system 1470 with transmit and receive signal paths. In the receive path, received RF signals can be coupled from a multiplexor to a low noise amplifier (not shown) that amplifies the received RF signal and sends the amplified signal to radio system 1465.

In an alternative embodiment, radio system 1465 may comprise one or more radios that are configured to communicate over various frequencies. In an embodiment, radio system 1465 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 1465 to baseband system 1460.

If the received signal contains audio information, then baseband system 1460 decodes the signal and converts it to an analog signal. Then the signal is amplified and sent to a speaker. Baseband system 1460 also receives analog audio signals from a microphone. These analog audio signals are converted to digital signals and encoded by baseband system 1460. Baseband system 1460 also encodes the digital signals for transmission and generates a baseband transmit audio signal that is routed to the modulator portion of radio system 1465. The modulator mixes the baseband transmit audio signal with an RF carrier signal, generating an RF transmit signal that is routed to antenna system 1470 and may pass through a power amplifier (not shown). The power amplifier amplifies the RF transmit signal and routes it to antenna system 1470, where the signal is switched to the antenna port for transmission.

Baseband system 1460 is also communicatively coupled with processor 1410, which may be a central processing unit (CPU). Processor 1410 has access to data storage areas 1415 and 1420. Processor 1410 is preferably configured to execute instructions (i.e., computer programs, such as disclosed application 412 or other software modules) that can be stored in main memory 1415 or secondary memory 1420. Computer programs can also be received from baseband processor 1460 and stored in main memory 1415 or in secondary memory 1420, or executed upon receipt. Such computer programs, when executed, enable system 1400 to perform the various functions of the disclosed embodiments.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

In an embodiment, systems, methods, and non-transitory computer-readable media are disclosed for optimizing network loads utilizing the SAFE-R framework. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

What is claimed is:

1. A computer-implemented method for controlling implementation of network-control actions in a communication network, the method comprising, by at least one hardware processor:
receiving telemetry associated with a network control context in the communication network;
determining, based at least in part on the telemetry, that the network control context satisfies one or more readiness criteria for action evaluation;
generating a plurality of candidate network-control actions for the network control context;
predicting, for at least one candidate network-control action of the plurality of candidate network-control actions, a post-action state of the network control context;
evaluating the plurality of candidate network-control actions based at least in part on the predicted post-action state;
selecting a candidate network-control action based on the evaluating;
determining that the selected candidate network-control action satisfies one or more deployment criteria;
providing the selected candidate network-control action to a network-control interface for implementation in the communication network;
receiving post-action telemetry after implementation of the selected candidate network-control action; and
initiating a corrective action when the post-action telemetry satisfies one or more rollback conditions.

2. The method of claim 1, wherein the network control context comprises a directed source-target relation between a source network element and a target network element, the directed source-target relation having at least one of a load condition, radio condition, mobility history, target-capacity condition, parameter state, policy state, prior-action history, or rollback history.

3. The method of claim 1, wherein the candidate network-control actions comprise respective changes to at least one of a cell individual offset, qOffsetCell, qOffsetFreq, reselection offset, handover offset, A3 offset, A5 threshold, B1 threshold, layer priority, carrier priority, hysteresis value, time-to-trigger value, antenna tilt value, neighbor-list entry, load-balancing parameter, carrier-selection parameter, or radio-access-technology selection parameter.

4. The method of claim 1, wherein determining that the network control context satisfies the one or more readiness criteria comprises determining a readiness score from at least one of load metrics, radio metrics, mobility metrics, target-capacity information, historical performance, policy information, contextual information, confidence information, or uncertainty information.

5. The method of claim 4, wherein determining the readiness score comprises maintaining a belief associated with a hidden readiness state and recursively updating the belief, using Bayesian estimation, based on an observation vector associated with the network control context.

6. The method of claim 1, wherein predicting the post-action state comprises applying a state-transition model to a current state of the network control context and the at least one candidate network-control action.

7. The method of claim 6, wherein the state-transition model comprises a Markov model in which a next state depends on the current state and the at least one candidate network-control action, and wherein the post-action state includes at least one predicted value of source load, target load, throughput, handover success, ping-pong rate, too-early handover rate, too-late handover rate, radio-link-failure risk, signaling load, or user experience.

8. The method of claim 1, wherein evaluating the plurality of candidate network-control actions comprises forming, for a candidate network-control action, a candidate-action context vector comprising a current state, a predicted post-action state, and one or more relation descriptors; comparing the candidate-action context vector with historical context vectors associated with prior actions; and determining an action score from historical outcomes associated with the historical context vectors.

9. The method of claim 8, wherein comparing the candidate-action context vector with the historical context vectors comprises applying a kernel-based candidate-action utility model to determine an expected utility and an uncertainty for the candidate network-control action, and wherein the action score is a risk-adjusted action score based on the expected utility and the uncertainty.

10. The method of claim 1, wherein generating or evaluating the plurality of candidate network-control actions comprises, for a serving cell and a plurality of neighbor cells:
constructing, for each neighbor cell, a feature vector comprising a load-difference feature, radio-feasibility feature, mobility-reliability feature, capacity feature, and risk feature;
computing a kernel score based on a similarity between the feature vector and a target feature vector;
normalizing kernel scores across the plurality of neighbor cells to obtain respective neighbor weights; and
mapping at least one of the neighbor weights to a change in a mobility-control parameter.

11. The method of claim 1, wherein the one or more deployment criteria comprise at least one of a readiness threshold, target-load ceiling, mobility-quality floor, handover-success floor, ping-pong ceiling, too-early handover ceiling, too-late handover ceiling, radio-link-failure ceiling, parameter limit, maximum step size, confidence threshold, uncertainty threshold, maintenance-window restriction, protected-cell rule, protected-band rule, rollout limit, blast-radius limit, conflict rule, approval requirement, or operator policy rule; and wherein, when a highest-ranked candidate network-control action fails a deployment criterion, the method comprises selecting a lower-ranked candidate network-control action that satisfies the one or more deployment criteria.

12. The method of claim 1, further comprising comparing an observed post-action state represented by the post-action telemetry with the predicted post-action state, wherein the one or more rollback conditions include a deviation between the observed post-action state and the predicted post-action state exceeding a drift threshold, and updating a prediction model or an action-evaluation model using an outcome of the corrective action.

13. A system for controlling implementation of network-control actions in a communication network, the system comprising:
at least one hardware processor; and
one or more memories storing instructions that, when executed by the at least one hardware processor, cause the system to:
receive telemetry associated with a network control context;
determine whether the network control context is eligible for action evaluation;
generate a plurality of candidate network-control actions for the network control context;
predict a respective post-action state for at least one of the candidate network-control actions;
evaluate the candidate network-control actions based at least in part on predicted post-action state information;
select a candidate network-control action based on the evaluation;
apply one or more guardrails to the selected candidate network-control action;
provide the selected candidate network-control action to a network-control interface for implementation when the selected candidate network-control action satisfies the one or more guardrails;
monitor post-action performance after implementation; and
initiate a rollback action when the post-action performance satisfies one or more rollback conditions.

14. The system of claim 13, wherein the instructions cause the system to evaluate the candidate network-control actions by applying at least one of a network simulation model, digital-twin model, state-transition model, or Markov model to generate the predicted post-action state, and to compare measured feedback received after implementation with the predicted post-action state.

15. The system of claim 13, wherein the candidate network-control actions comprise respective mobility-offset values determined using correction factors representing at least two of a bandwidth difference, a signal-to-interference-plus-noise condition, an interference condition, a serving-cell load, or a target-cell load.

16. The system of claim 13, wherein the instructions further cause the system to determine, from time-of-arrival measurements associated with a plurality of user devices, a distribution of user devices within a coverage area; generate a candidate antenna-tilt action based at least in part on the distribution; and evaluate the candidate antenna-tilt action together with a change to a reselection or handover parameter.

17. A computer-implemented method for controlling network parameters based on a recognized operating context, the method comprising, by at least one hardware processor:
storing a plurality of context-specific network configuration profiles, each network configuration profile associating a respective operating context with a plurality of network parameter values;
receiving current network telemetry associated with a portion of a communication network;
recognizing, based on the current network telemetry, external context information, historical pattern information, or a combination thereof, a current operating context associated with the portion of the communication network;
selecting, from the plurality of context-specific network configuration profiles, a network configuration profile associated with the current operating context;
generating a proposed network parameter set based on the selected network configuration profile and the current network telemetry;
determining that the proposed network parameter set satisfies one or more deployment criteria associated with the current operating context;
providing the proposed network parameter set to a network-control interface for implementation in the portion of the communication network; and
monitoring network performance after implementation of the proposed network parameter set.

18. The method of claim 17, wherein the current operating context comprises at least one of a time-of-day pattern, day-of-week pattern, commuting pattern, residential-use pattern, public-holiday pattern, venue event, severe-weather condition, seasonal traffic condition, outage condition, transportation condition, or special-event demand pattern.

19. The method of claim 17, wherein the selected network configuration profile is generated from network states and parameter values associated with multiple prior occurrences of the current operating context and comprises at least one of a demand map, expected performance state, candidate action set, readiness prior, prediction-model identifier, guardrail setting, rollback threshold, or historical outcome.

20. The method of claim 17, further comprising selecting, based on the current operating context, at least one of a readiness prior, prediction model, prediction horizon, guardrail set, rollback threshold, or advisory, supervised, or closed-loop operating mode, and updating the selected network configuration profile based on the monitored network performance.
